(19) United States
(12) Patent Application Publication
(10) Pub. No.: US 2015/0220190 A1
(43) Pub. Date: Aug. 6, 2015

(54) DISPLAY APPARATUS

(71) Applicant: SHARP KABUSHIKI KAISHA, Osaka-shi, Osaka (JP)

(72) Inventors: Yuhji Yashiro, Osaka-shi (JP); Kazutoshi Kida, Osaka-shi (JP); Hiromi Katoh, Osaka-shi (JP)

(73) Assignee: Sharp Kabushiki Kaisha, Osaka-shi (JP)

(21) Appl. No.: 14/426,474

(22) PCT Filed: Apr. 24, 2013
(86) PCT No.: PCT/JP2013/062092

§ 371 Date: Mar. 6, 2015

(30) Foreign Application Priority Data
Sep. 11, 2012 (JP) 2012-199990

(51) Int. Cl. G06F 3/041; G02F 1/1333; G02F 1/1335; G02F 1/13363; G06F 3/044; G02B 5/30

(52) U.S. Cl. CPC G06F 3/0412; G06F 3/044; G02B 5/3083; G02F 1/133528; G02F 1/13363; G02B 5/305; G02F 1/13338; G06F 2203/04101; G06F 2203/04103; G06F 2203/04104; G02F 2001/133638; G02F 2001/133531

(57) ABSTRACT

A display apparatus (1) includes (i) a polarizing plate provided so that a surface of the polarizing plate is a surface of a main body (10) of the display apparatus (1) and (ii) a touch panel (20) including a birefringent base material (31) whose optical axis is parallel or perpendicular to an absorption axis of the polarizing plate.

### TECHNICAL FIELD

The present invention relates to a display apparatus including a touch panel that includes a birefringent base material which touch panel polarized light enters, the polarized light having exited from a display panel (e.g., a liquid crystal panel) that includes a polarizing plate so that a surface of the polarizing plate is a surface of the display panel.

### BACKGROUND ART

As a touch panel conventionally known is an electrostatic capacitive touch panel which detects a contact position at which a detecting object, such as a finger or a pen for use in input, comes into contact with a display screen. The electrostatic capacitive touch panel detects the contact position by detecting a change in electrostatic capacitance caused by the contact.

In terms of cost, heat resistance, etc., a polyethylene terephthalate (PET) film etc. is conventionally and typically employed as a base material of a touch sensor of the touch panel (see, for example, Patent Literatures 1 and 2).

However, in a case where an observer who is wearing polarized glasses observes a liquid crystal display apparatus on which front surface a touch panel that includes a birefringent base material such as the PET film is provided, the observer visually recognizes rainbow unevenness (see, for example, Patent Literatures 1 and 2).

Patent Literature 1 discloses eliminating rainbow unevenness by making an optical compensation with use of a ¼ wavelength plate that is provided between a liquid crystal display apparatus including an electrostatic capacitive touch sensor and the electrostatic capacitive touch sensor, the rainbow unevenness being (i) visually recognized by a viewer with polarized glasses on when the viewer views the liquid crystal display apparatus and (ii) caused by beams of light passing through the polarized glasses to be combined with each other which beams of light have passed through the electrostatic capacitive touch sensor to make a phase difference.

Patent Literature 2 discloses preventing generation of rainbow unevenness which is visually recognized by a viewer with polarized glasses on when the viewer views a resistive film touch panel included in a liquid crystal display apparatus. Specifically, the generation of the rainbow unevenness is prevented by (i) providing a ¼ wavelength plate between the liquid crystal display apparatus and (a) a first surface of an upper electrode plate which first surface is opposite to a second surface of the upper electrode plate on which second surface a transparent electrically-conductive film is provided or (b) a first surface of a lower electrode plate which first surface is opposite to a second surface of the lower electrode plate on which second surface a transparent electrically-conductive film is provided, and (ii) converting, into circularly-polarized light, linearly-polarized light emitted from the liquid crystal display apparatus.

Patent Literature 2 further discloses absorbing light by use of a circularly-polarizing plate in which a ¼ wavelength plate and a polarizing plate are combined, the light internally reflecting after the light externally enters.

### CITATION LIST

### Patent Literatures

Patent Literature 1
Japanese Patent Application Publication, Tokukai, No. 2012-27622 (Publication Date: Feb. 9, 2012)

Patent Literature 2
Japanese Patent Application Publication, Tokukai, No. 2009-169837 (Publication Date: Jul. 30, 2009)

Patent Literature 3
Japanese Patent Application Publication, Tokukai, No. 2008-191544 (Publication Date: Aug. 21, 2008)

Patent Literature 4
Japanese Patent Application Publication, Tokukai, No. 2010-122599 (Publication Date: Jun. 3, 2010)

### SUMMARY OF INVENTION

### Technical Problem

However, Patent Literatures 1 and 2 disclose eliminating rainbow unevenness which is visually recognized by a viewer only when the viewer views, with polarized glasses on, a liquid crystal display apparatus including a touch panel.

As such, it is known that rainbow unevenness is visually recognized by a viewer when the viewer views, with polarized glasses on, a liquid crystal display apparatus including a touch panel. It is, however, unknown that rainbow unevenness is visually recognized by a viewer without polarized glasses on when the viewer views, at a certain viewing angle, a liquid crystal display apparatus including a touch panel.

Conventionally, a large-sized touch panel includes a glass sensor that includes a glass base material. Even if such a touch panel is provided on a front surface of a display apparatus such as a liquid crystal display apparatus, no rainbow unevenness is generated.

Rainbow unevenness is neither visually recognized in a case where a small-sized display apparatus including a touch panel (e.g., a mobile terminal) is normally used, for example, in a case where the display apparatus is viewed from the front of a screen while being held by a hand as it is normally used.

However, the inventors of the present invention found that, in a case where a touch panel in which a birefringent base material such as a PET film is employed as a base material is provided on a display panel (e.g., a liquid crystal panel) from which polarized light exits, rainbow unevenness is generated at a certain viewing angle. The inventors also found that, for example, in a case where a large-sized touch panel which is horizontally placed is viewed from an oblique direction, rainbow unevenness is constantly observed, and even in a case where a small-sized touch panel is used, rainbow unevenness is visually recognized depending on a viewing angle.

The inventors of the present invention further found that, in a case where a touch panel including a birefringent base material (e.g., a PET film) which causes a phase shift of linearly-polarized light which has entered the birefringent base material is provided on a main body of a display apparatus (e.g., a liquid crystal panel) which emits polarized light, rainbow unevenness is visually recognized at a certain viewing angle by a viewer even without polarized glasses on due to (i) a change in polarization state differing from one wavelength from another which change is caused by the birefringent base material and (ii) a polarization effect of interface reflection on an interface with an air layer. In other words, the inventors of the present invention found that, in the case where the touch panel including the birefringent base material (e.g., the PET film) is provided on the main body of the display apparatus (e.g., the liquid crystal panel) which emits polarized light, rainbow unevenness is visually recognized at the certain viewing angle by the viewer even without polarized glasses on because of the following reasons. That is, a phase of linearly-polarized light having entered the birefringent base material differs from one wavelength to another. Further, the interface reflection on the interface between the air layer and the touch panel including the birefringent base material has the polarization effect. In the case where the touch panel including the birefringent base material is provided on the main body of the display apparatus which emits polarized light, rainbow unevenness is visually recognized at the certain viewing angle by the viewer even without polarized glasses on due to (i) the change in the polarization state differing from one wavelength from another which change is caused by the birefringent base material and (ii) the polarization effect of the interface reflection on the interface between the touch panel and the air layer.

The inventors of the present invention further found that, even if polarized light which exits from a display panel such as a liquid crystal panel is converted into circularly-polarized light (as disclosed in Patent Literatures 1 and 2), the circularly-polarized light is linearly polarized due to interface reflection on an interface between a birefringent base material and a layer which is adjacent to the birefringent base material and made from a material different from that for the birefringent base material, and therefore, such rainbow unevenness is not eliminated.

The present invention was made to attain a novel object, found by the inventors of the present invention, of eliminating rainbow unevenness generated due to (i) a change in polarization state of polarized light emitted from a main body of a display apparatus and (ii) a polarization effect of interface reflection on an interface between an air layer and a touch panel that includes a birefringent base material which touch panel is provided on a front surface of the main body of the display apparatus.

### Solution to Problem

In order to attain the object, a display apparatus of the present invention is configured to be a display apparatus, including: a display panel from which polarized light exits; and a touch panel including at least one birefringent base material that has optical axes in respective two directions in a plane, the polarized light which has exited from the display panel entering the at least one birefringent base material, and one of the optical axes of the at least one birefringent base material being parallel or perpendicular to a polarization direction of the polarized light which enters the at least one birefringent base material.

As has been described, the inventors of the present invention found that, in a case where a touch panel including a birefringent base material is provided on a display panel, such as a liquid crystal panel, from which polarized light exits, rainbow unevenness (rainbow-like color band) is visually recognized by a viewer even without polarized glasses on at a certain viewing angle, particularly at a viewing angle at which a difference in transmittance between an s-wave and a p-wave on an interface of the touch panel which interface has a polarization effect is not less than 10%.

As a result of a further study, the inventors of the present invention found that such rainbow unevenness is caused due to (i) a change in polarization state that differs from one wavelength to another, the change being caused by the birefringent base material, and (ii) dependency, on the polarization state, of interface reflection on an interface between an air layer and a surface of the touch panel, e.g., a cover glass. The inventors of the present invention found that, specifically, the rainbow unevenness is generated by (i) a phase shift of linearly-polarized light due to a birefringent property of the birefringent base material and (ii) the polarization effect.

As such, one factor that causes the rainbow unevenness is the phase shift of the linearly-polarized light due to the birefringent property of the birefringent base material. It is therefore possible to prevent the phase shift of the linearly-polarized light and the rainbow unevenness by controlling an optical axis of the birefringent base material and a polarization direction of a polarizing plate of the display panel from which the linearly-polarized light enters the birefringent base material, i.e., by causing the optical axis to be parallel or perpendicular to the polarization direction.

A display apparatus including a touch panel, of the present invention, is configured to be a display apparatus, including:

(1) a display panel including a polarizing plate so that a surface of the polarizing plate is a surface of the display panel; and

(2) a touch panel including (i) at least one birefringent base material having optical axes in respective two directions in a plane and (ii) a protection plate provided so that the at least one birefringent base material is sandwiched between the protection plate and the display panel,

polarized light which has exited from the polarizing plate entering the at least one birefringent base material,

(A) a polarization direction of the polarizing plate being parallel to a longitudinal or traverse direction of a display surface of the display apparatus, and

(B) the display panel being provided with the touch panel so that an angle between one of the optical axes of the at least one birefringent base material and the polarization direction of the polarizing plate falls within a range from minus 11° to 11°.

Actually, a display apparatus including a touch panel, employed as, e.g., a digital signage or an electronic blackboard, is hardly viewed from obliquely above or from obliquely below. Therefore, in terms of practical use, the display apparatus needs only to prevent rainbow unevenness from being generated when the display apparatus is viewed from a horizontal and traverse direction.

The inventors of the present invention made a diligent study of how a display apparatus including a touch panel prevents rainbow unevenness from being visually recognized, the touch panel including a protection plate so that a surface of the protection plate is a first surface of the touch panel which first surface is opposite to a second surface of the touch panel which second surface faces a display panel, i.e., a surface of the touch panel which surface is closest to a viewer. As a result of the diligent study, the inventors of the present invention found the following result.

That is, the display apparatus needs to meet the following two conditions in order to prevent rainbow unevenness which can be generated when the display apparatus is viewed from a horizontal and traverse direction. Assume here that (i) an x-y planar surface is parallel to a display surface of the display apparatus and (ii) the horizontal and traverse direction from which the display apparatus which is stood is viewed is a y direction.

One of the two conditions is that an absorption axis of a polarizing plate of the display panel should be parallel to a longitudinal or traverse direction of the display surface of the display apparatus, i.e., an x direction or the y direction.

The other of the two conditions is that an angle between one of optical axes of a birefringent base material and the absorption axis of the polarizing plate of the display panel should fall within 11°.

The inventors of the present invention found that (i) rainbow unevenness is visually recognized most remarkably when the display apparatus including the touch panel that includes the protection plate is viewed at a viewing angle of 78°, and (ii) a rainbow-like color band starts to be visually recognized at a reflectivity of more than 12% at which an s-wave is reflected on an interface between an air layer and a protection layer that is provided so that a surface of the protection layer is the display surface.

Therefore, it is possible to prevent the rainbow unevenness from being visually recognized by causing the s-wave to be reflected on the interface between the air layer and the protection layer at a reflectivity of not more than 12% at the viewing angle of 78°.

The inventors of the present invention further found that it is possible to cause the s-wave to be reflected on the interface between the air layer and the protection layer at the reflectivity of not more than 12% at the viewing angle of 78°, by causing the angle between the one of the optical axes of the birefringent base material and a polarization direction of the polarizing plate to fall within a range from minus 11° to 11°.

Therefore, the display apparatus including the touch panel that includes the protection plate is configured so that (i) the absorption axis of the polarizing plate of the display panel is parallel to the longitudinal or traverse direction of the display surface of the display apparatus and (ii) the angle between the one of the optical axes of the birefringent base material and the absorption axis of the polarizing plate of the display panel falls within 11°. This configuration makes it possible to reduce a case where a viewer visually recognizes rainbow unevenness when the viewer views the display apparatus from a traverse direction that is a direction in which the display apparatus is actually viewed.

Needless to say, it is possible to further prevent generation of rainbow unevenness by causing the one of the optical axes of the birefringent base material to be parallel or perpendicular to the polarization direction of the polarizing plate.

Further, the invention of the present application can prevent generation of rainbow unevenness without additionally providing a film such as a ¼ wavelength plate in a typical display apparatus including a touch panel. It is therefore possible to reduce manufacturing cost.

### Advantageous Effects of Invention

Rainbow unevenness, which is generated in a case where a touch panel including a birefringent base material is provided on a display panel, is caused due to (i) a change in polarization state that differs from one wavelength to another, the change being caused by the birefringent base material, and (ii) dependency, on the polarization state, of interface reflection on an interface between an air layer and a surface of the touch panel, e.g., a cover glass. Specifically, the rainbow unevenness is caused by (i) a phase shift of linearly-polarized light due to a birefringent property of the birefringent base material and (ii) a polarization effect.

It is therefore possible to prevent the phase shift of the linearly-polarized light and the rainbow unevenness by controlling an angle between an optical axis of the birefringent base material and a polarization direction of polarized light which enters the birefringent base material so that the optical axis is parallel or perpendicular to the polarization direction.

### BRIEF DESCRIPTION OF DRAWINGS

(a) of FIG. 1 is a perspective diagram illustrating a display apparatus of an embodiment of the present invention in which display apparatus an optical axis of a birefringent base material extends in a polarization direction of polarized light from a main body of the display apparatus. (b) of FIG. 1 is a perspective diagram illustrating a conventional and typical display apparatus in which an optical axis of a birefringent base material does not extend in a polarization direction of polarized light from a main body of the conventional and typical display apparatus.

FIG. 2 is an exploded cross-sectional view illustrating a configuration of the display apparatus illustrated in (a) of FIG. 1.

(a) of FIG. 3 is a plain view illustrating a pattern shape of a Y electrode pattern of a touch panel provided in the display apparatus illustrated in (a) of FIG. 1. (b) of FIG. 3 is a plain view illustrating a pattern shape of an X electrode pattern of the touch panel.

(a) of FIG. 4 through (e) of FIG. 4 are cross-sectional views illustrating, in order of step, a method of producing a first sensor body of the touch panel.

(a) of FIG. 5 and (b) of FIG. 5 are exploded perspective views each schematically illustrating polarized light obtained in a case where a birefringent film base material is sandwiched between (i) a polarizing plate provided on an upper surface side of a liquid crystal panel and (ii) a polarizing plate provided on an upper surface side of the birefringent film base material.

FIG. 6 is an exploded cross-sectional view schematically illustrating a rainbow unevenness generation mechanism.

FIG. 7 is a graph illustrating (i) a relation between a viewing angle and each of a transmittance of an s-wave and a transmittance of a p-wave on an interface between an OCAT (Optical Clear Adhesive Tape) and a PET film, and (ii) a relation between the viewing angle and each of a transmittance of an s-wave and a transmittance of a p-wave on an interface between a glass and the OCAT.

FIG. 8 is a graph illustrating a relation between a viewing angle and each of a transmittance of an s-wave and a transmittance of a p-wave on an interface between the glass and an air layer.

FIG. 9 is a graph illustrating a relation between a viewing angle and a difference in transmittance between a p-wave and an s-wave.

FIG. 10 is a diagram illustrating a relation among (i) a display size of a display apparatus configured as illustrated in FIG. 6, (ii) viewing angles θ₁ through θ₃, and (iii) a viewing distance L.

FIG. 11 is a graph illustrating a relation between a viewing angle range and a display size in a case where the viewing distance L is 40 cm and a central viewing angle θ₁ is 30°.

FIG. 12 is an explanatory view explaining a relation between an optical axis of a birefringent base material and an absorption axis of a main body of a display apparatus 2 (illustrated in (b) of FIG. 1 and FIG. 6) including a touch panel.

FIG. 13 is an explanatory view emphatically illustrating a difference in direction between the optical axis of the birefringent base material and the absorption axis of the main body of the display apparatus 2.

FIG. 14 is a diagram illustrating dependency, on an angle between an optical axis of a birefringent base material and an absorption axis of a polarizing plate, of energy of transmitted light of each polarization direction on an interface between a protection layer and air.

(a) of FIG. 15 through (e) of FIG. 15 are cross-sectional views illustrating, in order of step, a method of producing a second sensor body of the touch panel.

(a) of FIG. 16 through (g) of FIG. 16 are cross-sectional views illustrating, in order of step, a method of producing a third sensor body of the touch panel.

(a) of FIG. 17 through (e) of FIG. 17 are cross-sectional views illustrating, in order of step, a method of producing a fourth sensor body of the touch panel.

FIG. 18 is a plain view illustrating pattern shapes of a Y electrode pattern and an X electrode pattern which are included in a single-side sensor film.

(a) of FIG. 19 through (c) of FIG. 19 are cross-sectional views illustrating, in order of step, a method of producing a fifth sensor body of the touch panel.

(a) of FIG. 20 through (e) of FIG. 20 are cross-sectional views illustrating, in order of step, a method of producing a sixth sensor body of the touch panel.

### DESCRIPTION OF EMBODIMENTS

The following description will discuss an embodiment of the present invention with reference to FIG. 1 through (a) through (e) of FIG. 20.

<Outline of the Present Invention>

(a) of FIG. 1 is a perspective diagram illustrating a display apparatus 1 of an embodiment of the present invention in which display apparatus an optical axis of a birefringent base material extends in a polarization direction of polarized light from a main body of the display apparatus 1. (b) of FIG. 1 is a perspective diagram illustrating a conventional and typical display apparatus 2 in which an optical axis of a birefringent base material does not extend in a polarization direction of polarized light from a main body of the display apparatus 2. Note that a polarization direction means a direction in which light oscillates in an electric field.

The display apparatus 1 is identical in configuration to the display apparatus 2 except that, in the display apparatus 1, the optical axis of the birefringent base material extends in the polarization direction of the polarized light from the main body of the display apparatus 1, whereas, in the display apparatus 2, the optical axis of the birefringent base material does not extend in the polarization direction of the polarized light from the main body of the display apparatus 2.

The present invention provides a display apparatus in which an optical axis of a birefringent base material extends in a polarization direction of polarized light from a main body of the display apparatus. This makes it possible to prevent linearly-polarized light having entered the birefringent base material from causing a phase shift which differs from one wavelength to another, thereby preventing a rainbow-like color band from being generated on a display screen.

The following description will schematically discuss how to prevent generation of the rainbow-like color band by extending the optical axis of the birefringent base material in the polarization direction of the polarized light from the main body of the display apparatus.

Note here that a display apparatus including a touch panel is typically configured so that the touch panel, which includes (i) a protection layer whose surface is a surface of the touch panel and (ii) a birefringent base material such as a polyethylene terephthalate (PET) film, is provided on a front surface of a main body of a liquid crystal display apparatus which emits polarized light.

A viewer who views the display apparatus including the touch panel sometimes visually recognizes rainbow unevenness at a viewing angle even if the viewer views the display apparatus without polarized glasses on (described later in detail).

The polarized light having been emitted from the main body of the display apparatus 2, in which the optical axis of the birefringent base material does not extend in the polarization direction of the polarized light from the main body of the display apparatus 2 (see (b) of FIG. 1), is in a polarization state in the birefringent base material, the polarization state differing from one wavelength from another. Transmitted light is colored due to a polarization effect of interface reflection on an interface between air and a protection layer whose surface is a surface of a touch panel. Since a retardation differs from one viewing angle to another, light which passes through the interface between air and the protection layer that serves as a polarizer has a wavelength which differs from one viewing angle to another. Therefore, a rainbow-like color band is visually recognized.

In the display apparatus 1, the optical axis of the birefringent base material extends in the polarization direction of the polarized light from the main body of the display apparatus 1. Therefore, the polarized light having been emitted from the main body of the display apparatus 1 is not in a polarization state in the birefringent base material, the polarization state differing from one wavelength from another. Therefore, even if a polarization effect of interface reflection on an interface between air and a protection layer whose surface is a surface of a touch panel is exerted, transmitted light is not colored.

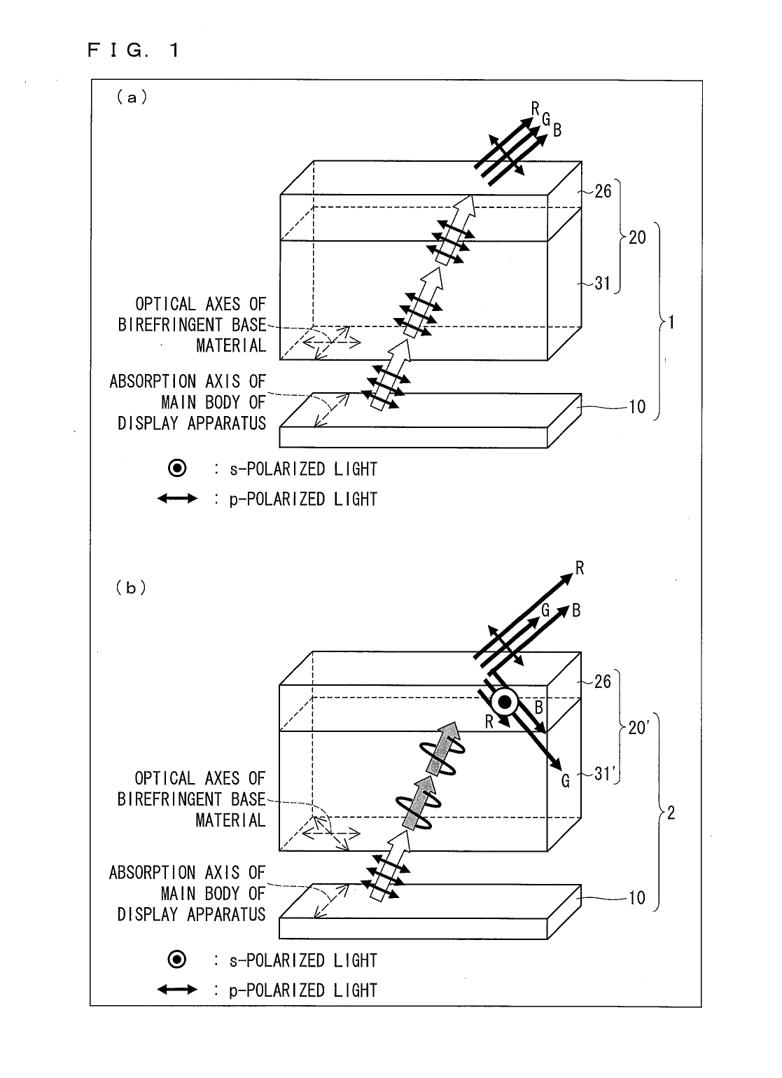

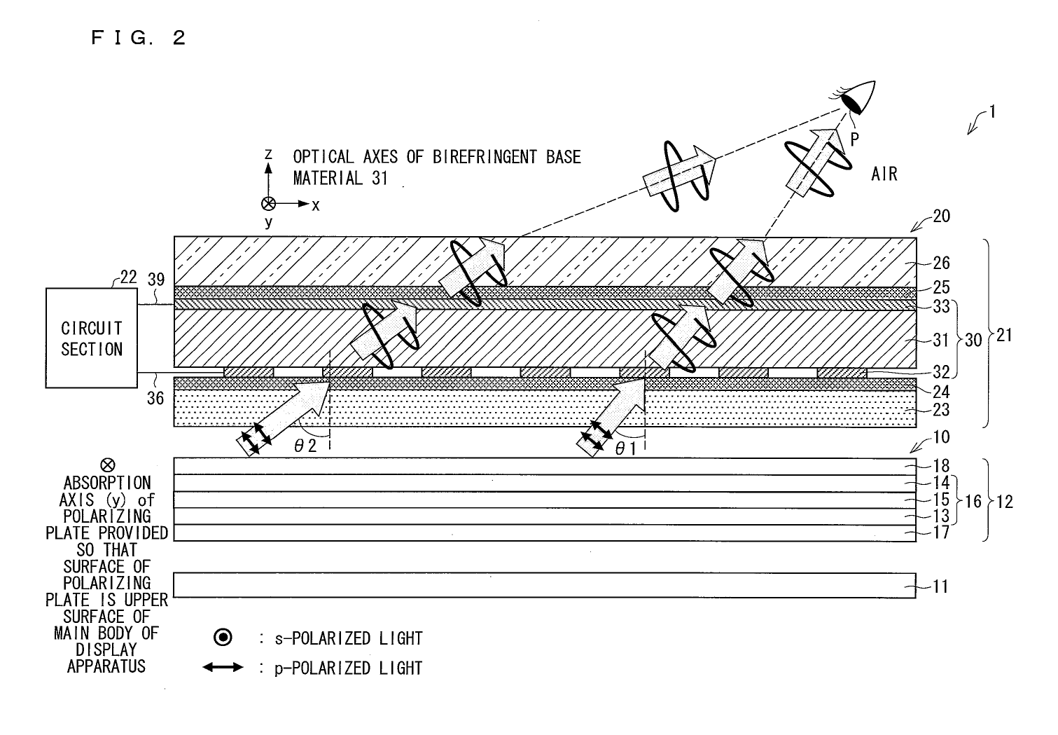

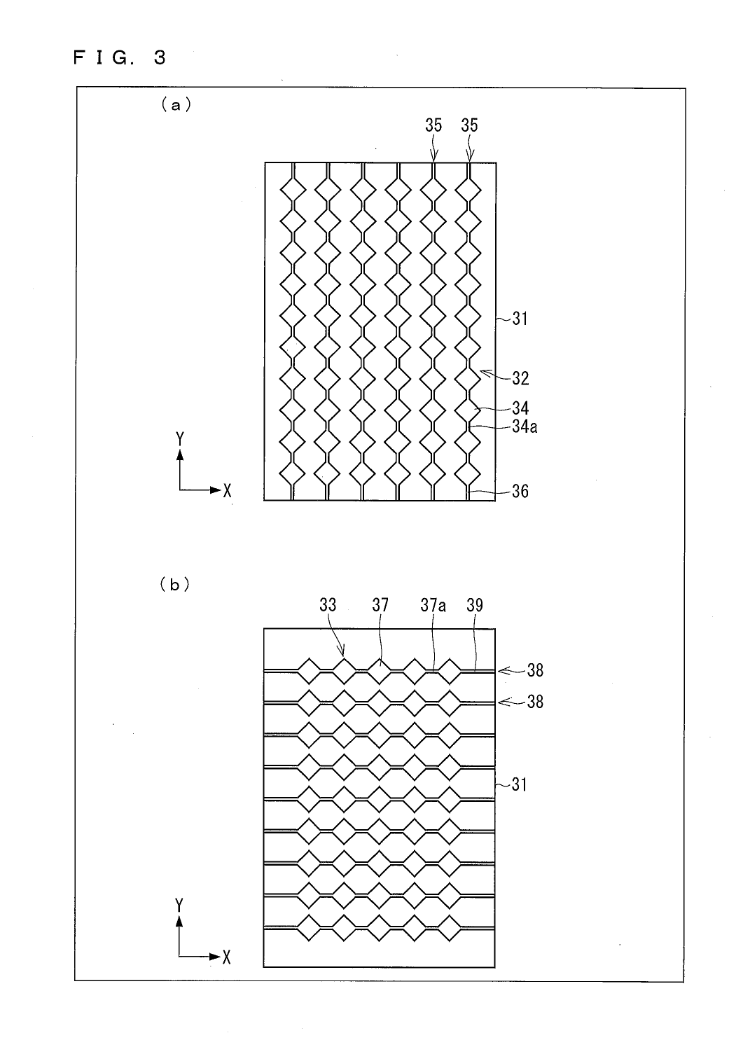

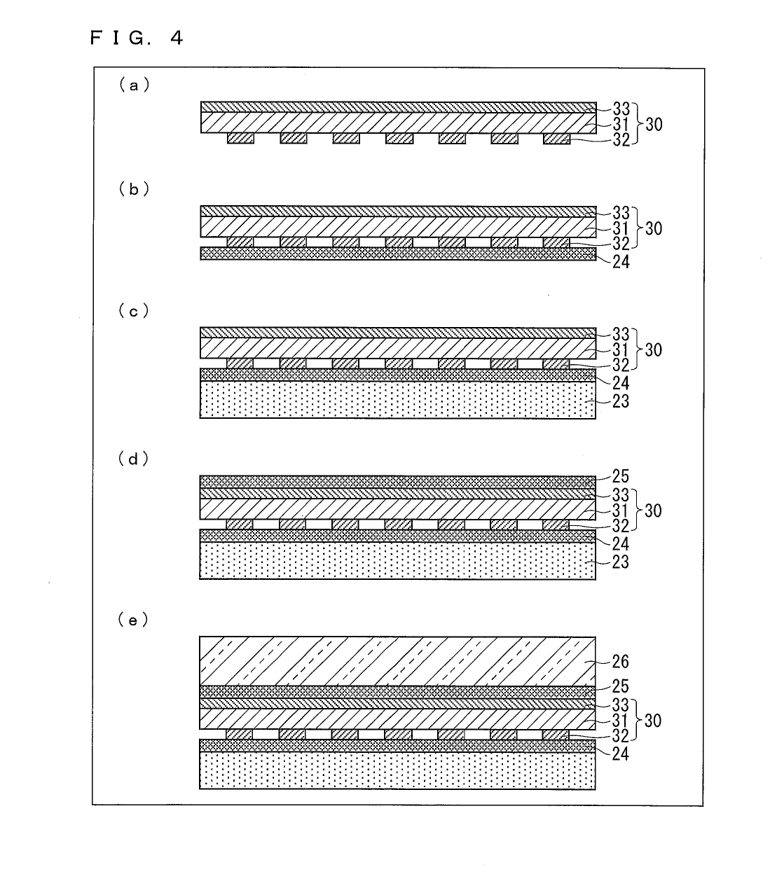

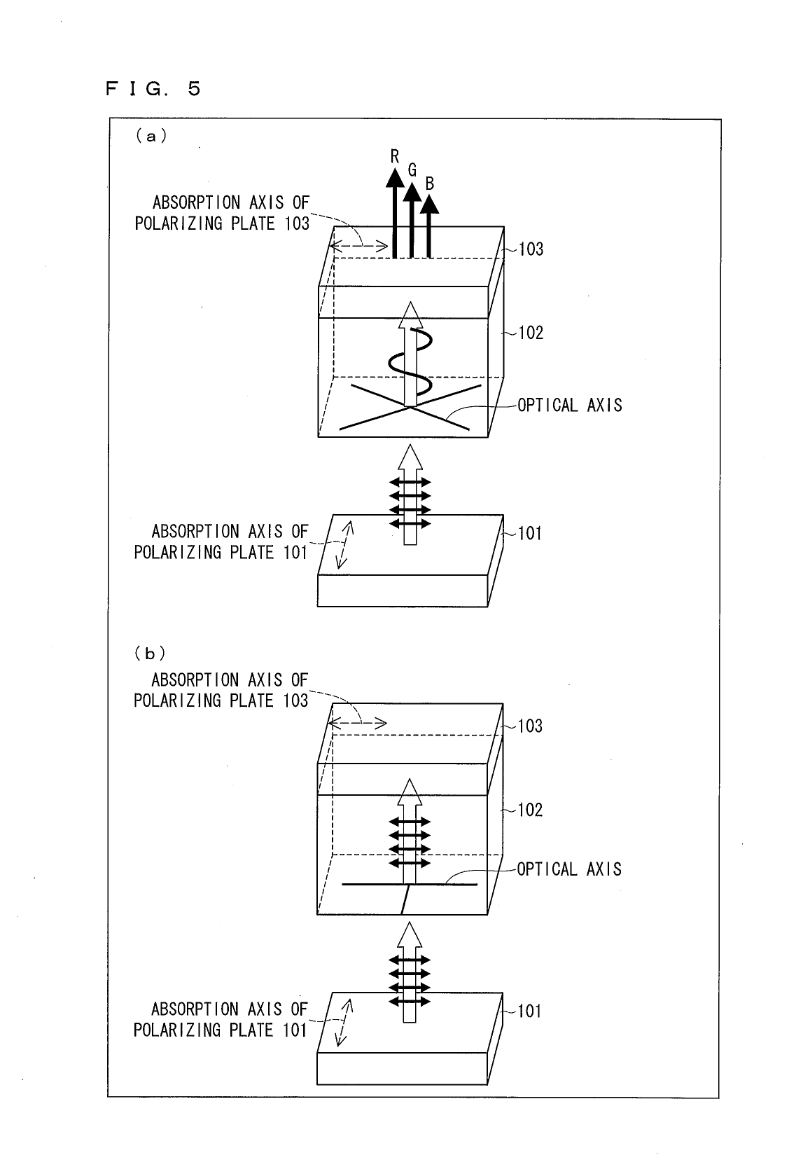

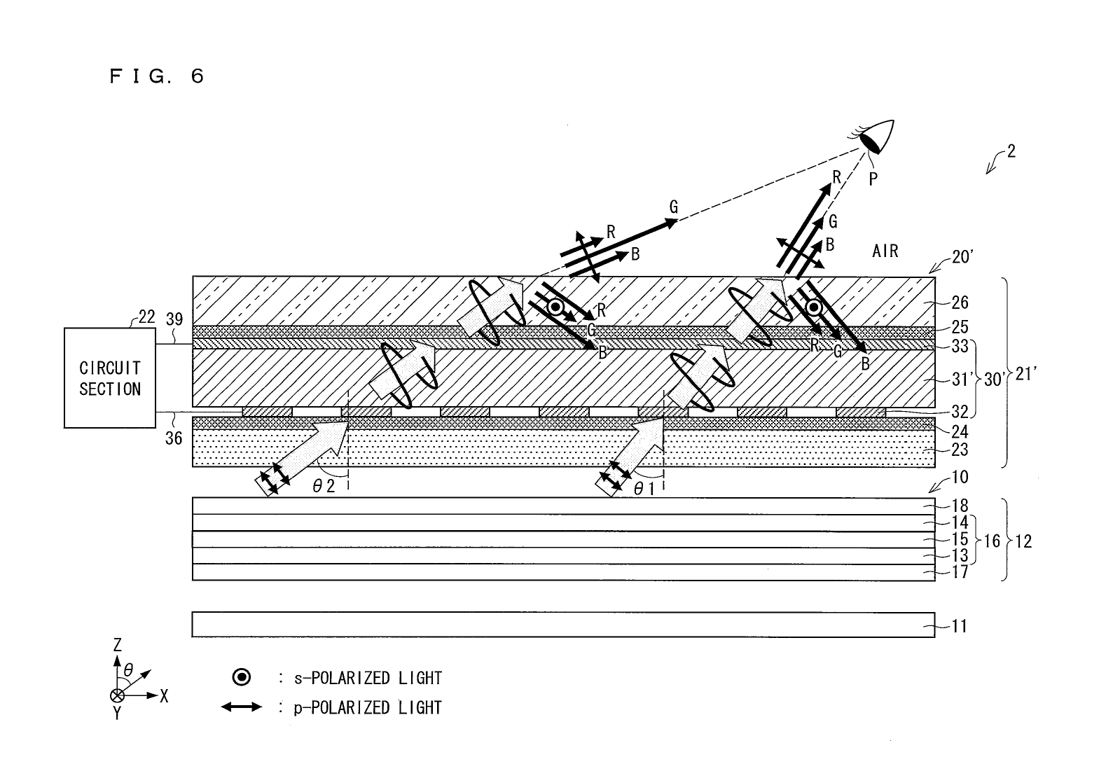

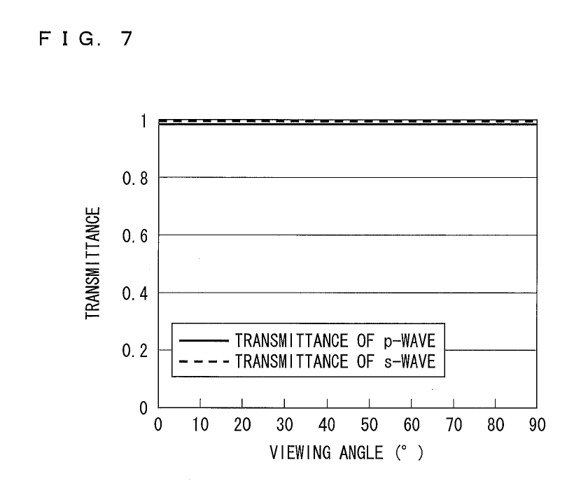

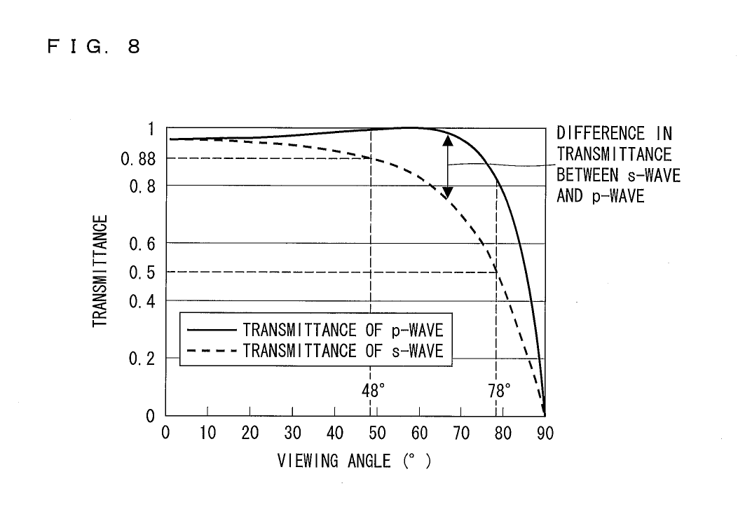

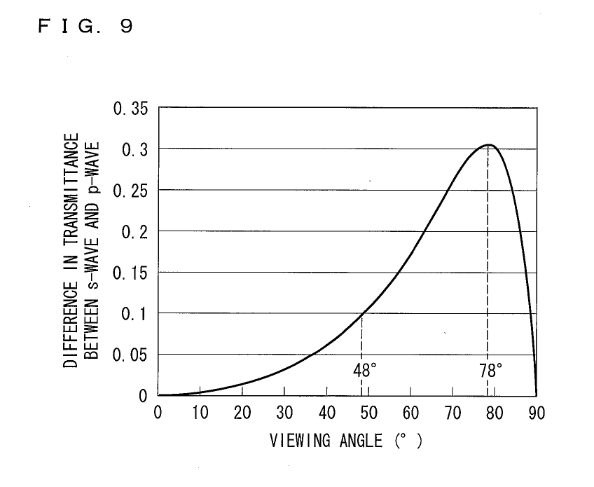

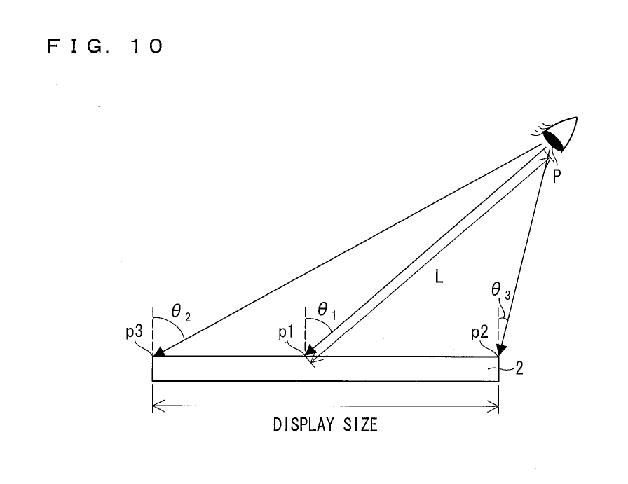

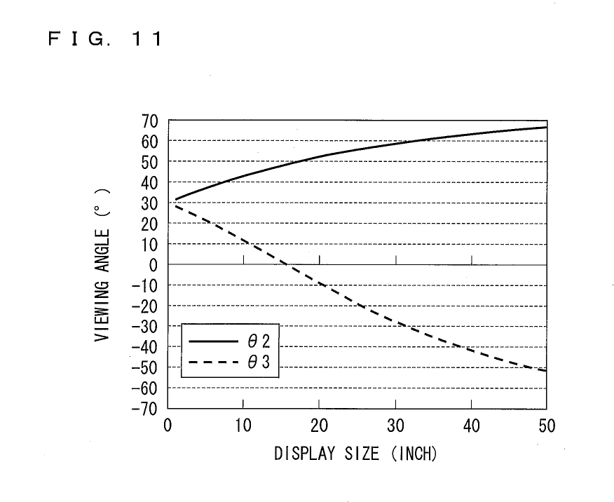

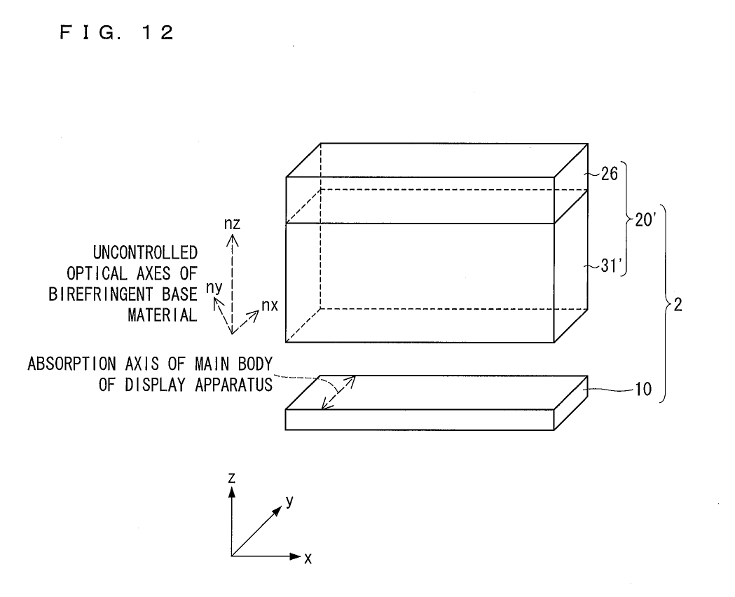

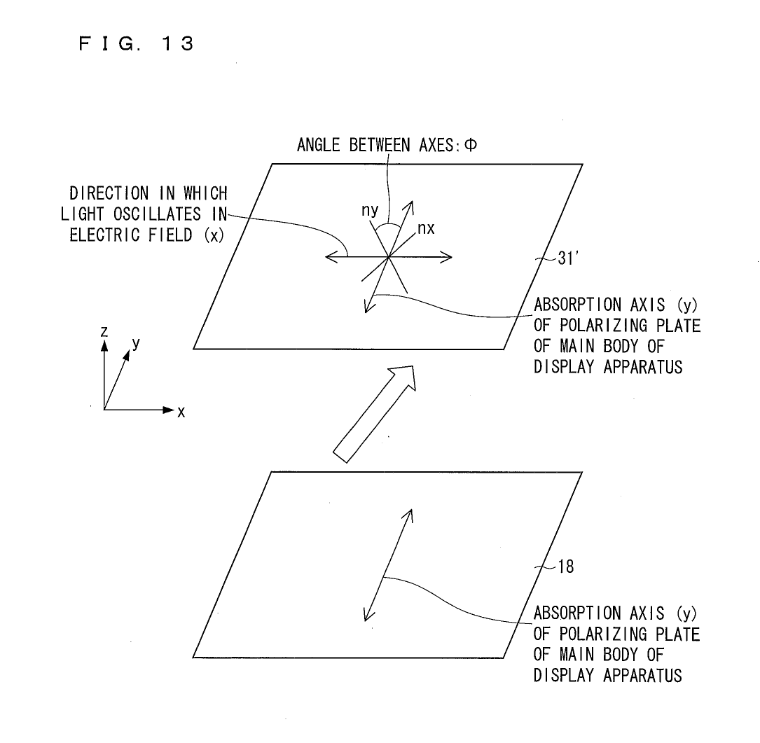

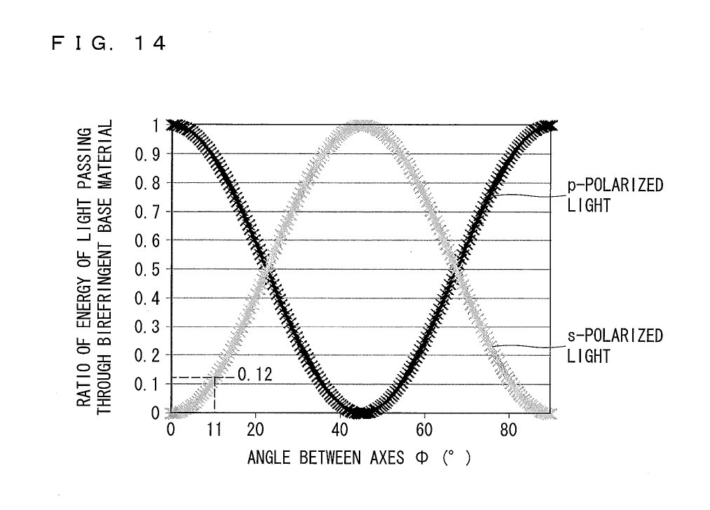

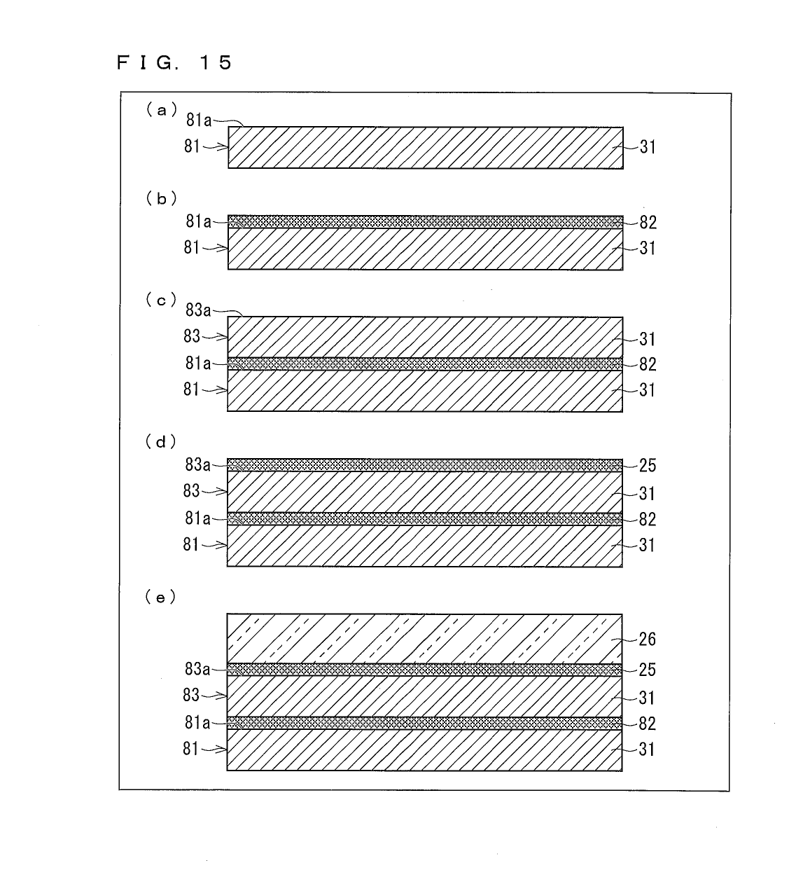

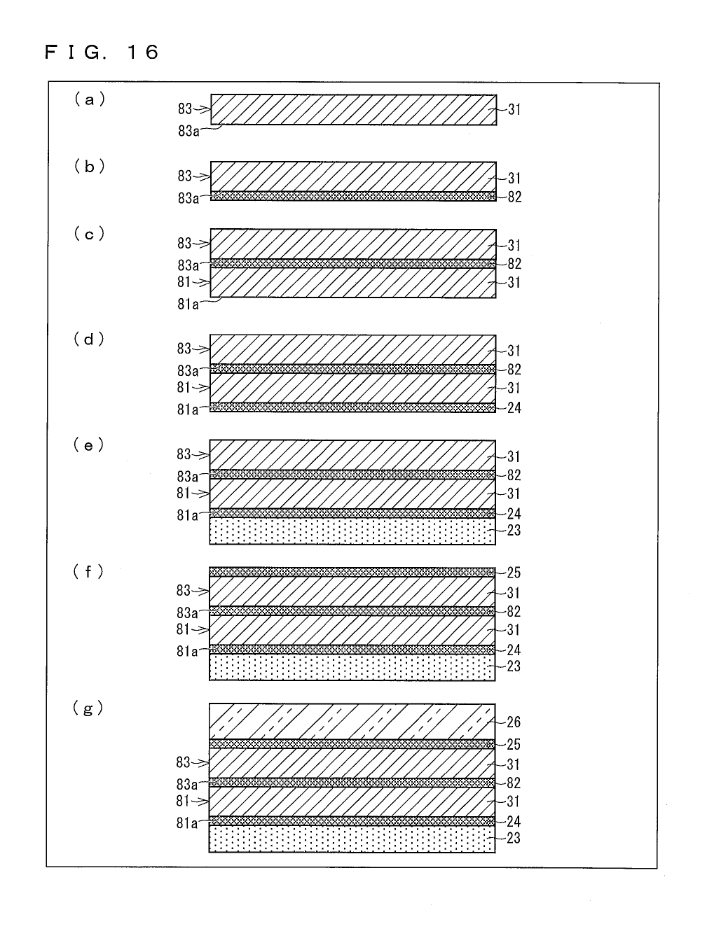

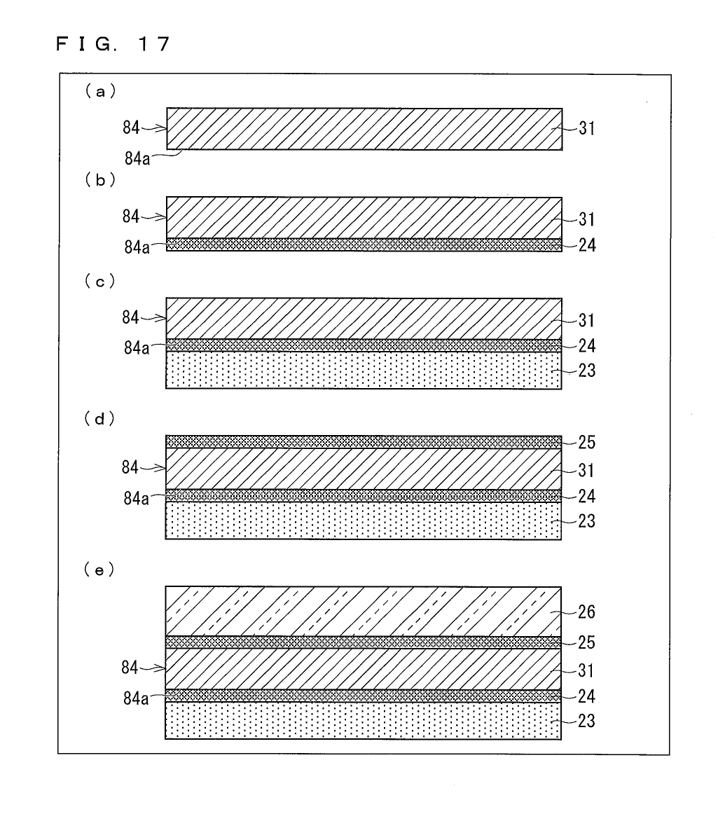

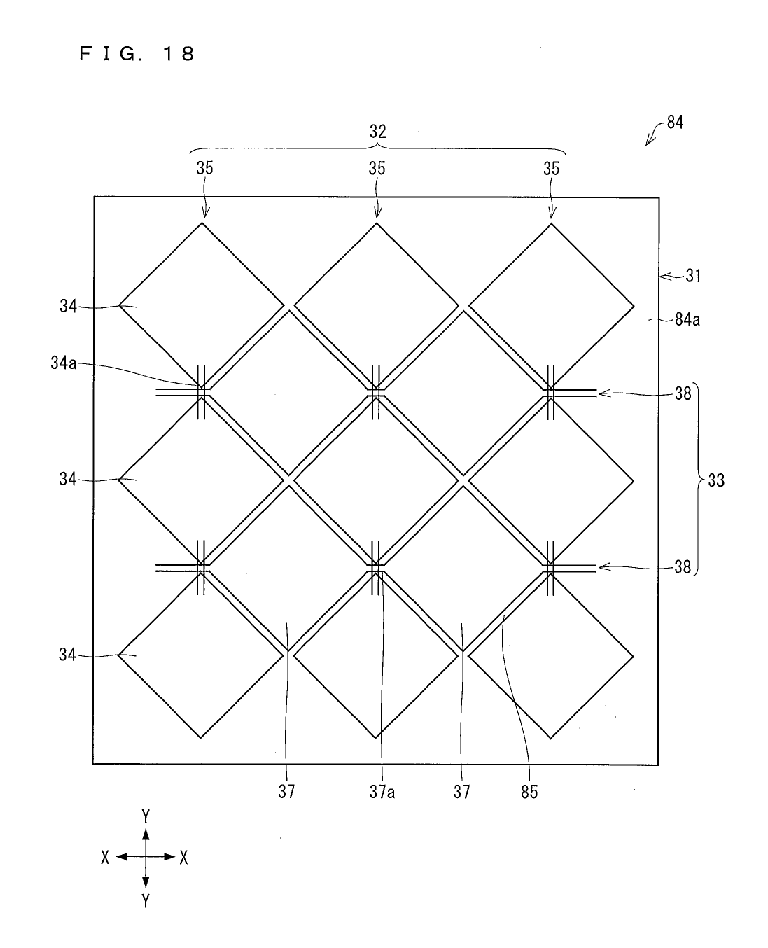

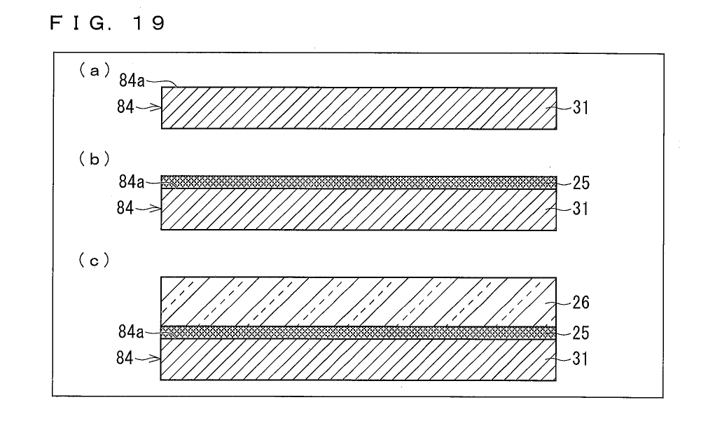

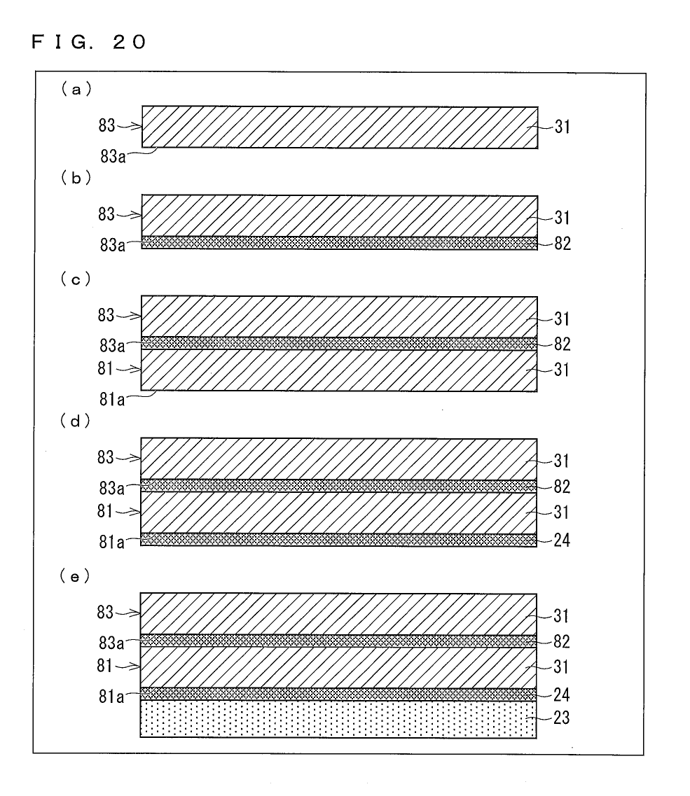

The configuration of the display apparatus 1 will be described below in detail with reference to FIG. 2.

<Schematic Configuration of Display Apparatus 1>

FIG. 2 is an exploded cross-sectional view illustrating the configuration of the display apparatus 1.

The display apparatus 1 is a display apparatus including a touch panel. The display apparatus 1 includes (i) a main body 10 (display section) that includes polarizing plates from which polarized light exits and (ii) a touch panel 20 (sensor section) that includes a birefringent base material (birefringence base material) (see FIG. 2).

Note that, in the present embodiment, an observer side (display surface side) is hereinafter referred to as an upper surface side or a front surface side, whereas a side opposite to the observer side is hereinafter referred to as a lower surface side or a back surface side.

<Main Body 10 of Display Apparatus 1>

An example of the main body 10 which emits polarized light is a display apparatus, such as a liquid crystal display apparatus, which includes a display panel that includes polarizing plates so that surfaces of the polarizing plates are surfaces of the display panel.

The main body 10 of the display apparatus 1 such as the liquid crystal display apparatus includes, for example, (i) a display panel 12 such as a liquid crystal panel and (ii) a backlight 11 which emits light so that the light enters the display panel 12 (see FIG. 2).

The display panel 12 such as the liquid crystal panel includes (i) a display cell 16 in which a layer of a display medium such as liquid crystal, i.e., an optical modulation layer 15 is sandwiched between a pair of substrates 13 and 14 and (ii) a pair of polarizing plates 17 and 18 (a lower polarizing plate and an upper polarizing plate) which are provided as a polarizer and an analyzer outside of the display cell 16, i.e., on opposite surfaces of the display cell 16 which are (i) a first surface of the substrate 13 which first surface is opposite to a second surface of the substrate 13 which second surface faces the optical modulation layer 15 and (ii) a first surface of the substrate 14 which first surface is opposite to a second surface of the substrate 14 which second surface faces the optical modulation layer 15. In other words, the display panel 12 includes (i) the display cell 16 as the optical modulation layer 15 and (ii) the pair of polarizing plates 17 and 18 (the lower polarizing plate and the upper polarizing plate) which are provided as the polarizer and the analyzer outside of the display cell 16. The display cell 16 is configured such that the layer of the display medium such as liquid crystal is sandwiched between the pair of substrates 13 and 14.

Note that an electrode etc. (not illustrated) which generates an electric field to be applied to the optical modulation layer 15 is provided on a surface of at least one of the pair of substrates 13 and 14 which surface faces the other of the pair of substrates 13 and 14.

The present embodiment will describe below a case where the display panel 12 is the liquid crystal panel, and the main body 10 is the liquid crystal display apparatus.

The liquid crystal panel used in the present embodiment is not particularly limited. Various publicly-known liquid crystal panels can be employed as the liquid crystal panel. A display method (driving method) of the display panel is neither limited to a specific method. Various publicly-known methods such as a TN (Twisted Nematic) method can be employed as the display method. Note that, since the liquid crystal panel has a conventionally publicly-known configuration, details of the configuration are neither described nor illustrated.

<Touch Panel 20>

The touch panel 20 of the present embodiment is an electrostatic capacitive touch panel. The touch panel 20 includes (i) a sensor body 21 that is a touch sensor, provided on the main body 10 and (ii) a circuit section 22 connected to the sensor body 21 (see FIG. 2).

An electrostatic capacitive touch sensor includes an electrode pattern (sensor electrode pattern) formed on a single surface of or opposite surfaces of a single birefringent base material (birefringence base material) or a layer stack in which birefringent base materials are stacked.

The sensor body 21 of the present embodiment includes a protection film 23 (first protection layer), an adhesive layer 24 (first adhesive layer), a double-side sensor film 30, an adhesive layer 25 (second adhesive layer), and a protection plate 26 (second protection layer), which are provided in this order from a main body 10 side (see FIG. 2).

<Double-Side Sensor Film 30>

The double-side sensor film 30 includes (i) a birefringent base material 31 and (ii) a Y electrode pattern 32 (first electrode pattern) and an X electrode pattern 33 (second electrode pattern) which are provided as electrode patterns on respective back and front surfaces of the birefringent base material 31.

(a) of FIG. 3 is a plain view illustrating a pattern shape of the Y electrode pattern 32. (b) of FIG. 3 is a plain view illustrating a pattern shape of the X electrode pattern 33.

As illustrated in (a) of FIG. 3, the Y electrode pattern 32 is constituted by a Y electrode group including a plurality of Y electrode columns 35 in each of which Y electrode columns 35 a plurality of Y electrodes 34 are aligned in a Y direction (a Y-axis direction that is a column direction, a first direction). A Y electrode 34 is a substantially-rectangular island-shaped electrode. The plurality of Y electrodes 34 are connected at their corner portions to a connection line 34a in the Y direction.

On the other hand, as illustrated in (b) of FIG. 3, the X electrode pattern 33 is constituted by an X electrode group including a plurality of X electrode rows 38 in each of which X electrode rows 38 a plurality of X electrodes 37 are aligned in an X direction (an X-axis direction that is a row direction, a second direction). An X electrode 37 is a substantially-rectangular island-shaped electrode. The plurality of X electrodes 37 are connected at their corner portions to a connection line 37a in the X direction.

When viewed from above (i.e., when viewed from a direction perpendicular to a film surface of the double-side sensor film 30), these Y electrodes 34 and X electrodes 37 are arranged so that (i) each of the Y electrodes 34 is located between corresponding two adjacent ones of the X electrodes 37 and (ii) each of the X electrodes 37 is located between corresponding two adjacent ones of the Y electrodes 34. When viewed from obliquely above, these Y electrodes 34 and X electrodes 37 are arranged alternately so as to form a checkered pattern, and are arranged alternately in the Y direction and in the X direction.

These Y electrodes 34 and X electrodes 37 are a position detecting electrode which detects a change in electrostatic capacitance to detect a position of coordinates specified by a detecting object such as a finger. These Y electrodes 34 and X electrodes 37 are arranged in a region corresponding to a display region of the display panel 12.

As illustrated in (a) of FIG. 3, each of the Y electrode columns 35 has an end part at which a drawing wiring 36 is provided in a direction in which the each of the Y electrode columns 35 extends. Similarly, as illustrated in (b) of FIG. 3, each of the X electrode rows 38 has an end part at which a drawing wiring 39 is provided in a direction in which the each of the X electrode rows 38 extends. Each of the drawing wirings 36 and 39 is a detection line for drawing a detection signal from a corresponding one of the Y electrode columns 35 and the X electrode rows 38. These drawing wirings 36 and 39 are provided in a region corresponding to a frame region of the display panel 12. These drawing wirings 36 and 39 are connected to the circuit section 22 (see FIG. 2).

Ones of the Y electrodes 34 and the X electrodes 37 are employed as driving electrodes, whereas the others of the Y electrodes 34 and the X electrodes 37 are employed as sensing electrodes. The Y electrodes 34 are configured so that a driving circuit section (not illustrated) applies a driving voltage to the Y electrodes 34. The X electrodes 37 are configured so that a driving circuit section (not illustrated) applies a driving voltage to the X electrodes 37.

These Y electrodes 34 and X electrodes 37 form electrostatic capacitance by the driving voltages being applied thereto. The electrostatic capacitance which is being formed by these Y electrodes 34 and X electrodes 37 changes when a fingertip, which is an electric conductor and serves as the detecting object, comes into contact with a surface of the touch panel 20. By detecting quantity of change in the electrostatic capacitance, it is possible to detect coordinate positions of an X coordinate and a Y coordinate at which coordinate positions the fingertip came into contact with the surface of the touch panel 20.

<Circuit Section 22>

As has been described, (i) the drawing wiring 36 provided at the end part of the each of the Y electrode columns 35 of the double-side sensor film 30, and (ii) the drawing wiring 39 provided at the end part of the each of the X electrode rows 38 of the double-side sensor film 30, are connected to the circuit section 22 (see FIG. 2).

As the circuit section 22 employed is an IC chip, an FPC (Flexible Printed Circuit) substrate, or the like.

The circuit section 22 includes, for example, a position detecting circuit (not illustrated) for detecting coordinate positions of the detecting object. The position detecting circuit detects the quantity of the change in the electrostatic capacitance formed by the Y electrodes 34 and the X electrodes 37, and calculates a position of the fingertip based on the quantity of the change.

Note that a conventionally-known circuit can be employed as the position detecting circuit. An example of the conventionally-known circuit is a mutual capacitive position detecting circuit which is in widespread use in an electrostatic capacitive touch panel. The position detecting circuit is not limited to a specific one.

<Protection Layer and Adhesive Layer>

As has been described, the protection film 23 is adhered via the adhesive layer 24 on a back surface side (lower surface side) of the double-side sensor film 30 so as to protect a sensor surface (electrode forming surface) on the back surface side (lower surface side) of the double-side sensor film 30. Further, the protection plate 26 is adhered via the adhesive layer 25 on a front surface side (upper surface side) of the double-side sensor film 30 so as to protect a sensor surface on the front surface side (upper surface side) of the double-side sensor film 30.

Examples of these protection layers (the protection film 23 and the protection plate 26) include (i) a plastic film or a plastic substrate made from a transparent resin such as polyethylene terephthalate (PET), triacetyl cellulose (TAC), polycarbonate (PC) or polymethyl methacrylate (PMMA), and (ii) a glass substrate such as a cover glass.

It is possible to adhere these protection layers to the double-side sensor film 30, for example, by combining the plastic film or the plastic substrate, the glass substrate, and the like with the double-side sensor film 30 via the adhesive layers 24 and 25.

These protection layers are not particularly limited in their thicknesses. The thicknesses can be determined in the same manner as that of a protection layer (a protection plate, a protection sheet) for conventional use in a touch panel.

Note that an adhesive material such as an OCAT (Optical Clear Adhesive Tape) can be employed as the adhesive layers 24 and 25.

<Method of Producing Touch Panel 20>

Of a method of producing the touch panel 20, a method of producing the sensor body 21 of the touch panel 20 will be described below with reference to (a) of FIG. 4 through (e) of FIG. 4.

(a) of FIG. 4 through (e) of FIG. 4 are cross-sectional views illustrating, in order of step, a method of producing a sensor body 21 of a touch panel 20. Note that (a) of FIG. 4 does not illustrate drawing wirings 36 and 39, and (b) of FIG. 4 through (e) of FIG. 4 do not illustrate a Y electrode pattern 32, an X electrode pattern 33, and the drawing wirings 36 and 39.

First, the X electrode pattern 33 and the Y electrode pattern 32 are formed on respective front and back surfaces of a birefringent base material 31 with use of, e.g., a transparent electrode or a meshed thin metallic wire, so that a double-side sensor film 30 is formed (see (a) of FIG. 4).

The X electrode pattern 33 and the Y electrode pattern 32 can be formed, for example, by (1) combining a metallic foil with the birefringent base material 31, and then etching the metallic foil by means of publicly-known lithography etc., (2) sputtering a metal on the birefringent base material 31, or (3) printing metallic paste on the birefringent base material 31.

An Example of the birefringent base material 31 is an insulating base material made from a transparent resin such as polyethylene terephthalate (PET), polycarbonate (PC), or polymethyl methacrylate (PMMA).

Generally, a birefringent index of a birefringent base material is neither controlled nor uniform in a plane of the birefringent base material. That is, the birefringent index varies in the plane of the birefringent base material.

Note, however that, according to the present embodiment, an optical axis of the birefringent base material 31 extends in a polarization direction of a polarizing plate 18 of a main body 10 of a display apparatus 1 (as has been described). Specifically, a y direction that is one component of the optical axis of the birefringent base material 31 equals to an absorption axis (y direction) of the polarizing plate 18.

Therefore, linearly-polarized light which has entered the birefringent base material 31 from the main body 10 of the display apparatus 1 is not in a polarization state in the birefringent base material 31, the polarization state differing from one wavelength from another. Even if a polarization effect of interface reflection on an interface between air and a protection layer 26 whose surface is a surface of the touch panel 20 is exerted, transmitted light is not colored.

An example of the metallic foil is a copper foil. An example of the metal which is sputtered on the birefringent base material 31 is silver. An example of the metallic paste is silver paste containing minute silver particles.

In a case where the Y electrode pattern 32 and the X electrode pattern 33 are formed with use of the transparent electrode, an example of an electrode material for the transparent electrode is a transparent electrically-conductive material that contains an oxide such as an ITO (indium tin oxide), an IZO (indium zinc oxide), a zinc oxide, or a tin oxide.

A size, thickness, line width, and the like of each electrode (Y electrode 34 and X electrode 34) of the Y electrode pattern 32 and the X electrode pattern 33 can be determined in the same manner as those of an electrode used in a conventional touch panel. The size, thickness, line width, and the like need only to be determined as appropriate according to the electrode material so that a desired physical property is obtained.

After the double-side sensor film 30 is formed, an adhesive layer 24 such as an OCAT is formed on a lower surface side of the double-side sensor film 30 (see (b) of FIG. 4). Then, a protection film 23 is adhered via the adhesive layer 24 to the double-side sensor film 30 (see (c) of FIG. 4).

Subsequently, an adhesive layer 25 such as an OCAT is formed on an upper surface side of the double-side sensor film 30 (see (d) of FIG. 4). Then, a protection plate 26 is adhered via the adhesive layer 25 to the double-side sensor film 30 (see (e) of FIG. 4).

<Rainbow-Like Color Band (Rainbow Unevenness) Generation Mechanism>

Before an effect of the display apparatus 1 of the present embodiment is described, a rainbow-like color band (rainbow unevenness) generation mechanism will be described below.

In terms of cost, heat resistance, etc., a birefringent base material made from, e.g., PET is typically employed as a base material of a sensor film of a touch sensor. On the other hand, a birefringent index of the birefringent base material is neither generally controlled nor uniform in a plane of the birefringent base material (as has been described).

Linearly-polarized light which has entered the birefringent base material whose birefringent index is not uniform in the plane of the birefringent base material causes a phase shift. In a case where a touch panel including this birefringent base material is provided on a display panel, such as a liquid crystal panel, from which polarized light exits, a rainbow-like color band is generated on a display screen at a certain viewing angle.

“Rainbow-like color band” is a phenomenon induced due to a difference, from one wavelength to another, in quantity of light which can pass through a layer having a linear polarization effect after the light passes through a birefringent base material. The difference is made by the birefringent base material converting linearly-polarized light so that the linearly-polarized light has a polarization direction which differs from one wavelength to another.

The rainbow-like color band (rainbow unevenness) generation mechanism will be specifically described below with reference to (a) and (b) of FIG. 5 through FIG. 11.

(a) of FIG. 5 and (b) of FIG. 5 are exploded perspective views each schematically illustrating polarized light obtained in a case where a birefringent film base material employed as a birefringent base material is sandwiched between (i) a polarizing plate (polarizer) provided on an upper surface side of a liquid crystal panel and (ii) a polarizing plate (analyzer) provided on an upper surface side of the birefringent film base material.

Specifically, (a) of FIG. 5 is an exploded perspective view illustrating a case where an optical axis of the birefringent film base material is not identical in direction to an absorption axis of the polarizing plate of the liquid crystal panel, whereas (b) of FIG. 5 is an exploded perspective view illustrating a case where the optical axis of the birefringent film base material is identical in direction to the absorption axis of the polarizing plate of the liquid crystal panel. Note that two-directional arrows in (a) and (b) of FIG. 5 represent p-polarized light.

As illustrated in (b) of FIG. 5, in a case where an optical axis of a birefringent film base material 102 is identical in direction to an absorption axis of a polarizing plate 101 of a liquid crystal panel, an oscillatory electric field is not decomposed along the optical axis of the birefringent film base material 102, and polarized light which has entered the birefringent film base material 102 is kept as it is. Therefore, the polarized light which has entered the birefringent film base material 102 is absorbed by a polarizing plate 103.

On the other hand, as illustrated in (a) of FIG. 5, in a case where the optical axis of the birefringent film base material 102 is not identical in direction to the absorption axis of the polarizing plate 101 of the liquid crystal panel (i.e., in a case where the optical axis of the birefringent film base material 102 does not extend in a polarization direction of polarized light which exits from the liquid crystal panel), the oscillatory electric field is decomposed along the optical axis of the birefringent film base material 102. In this case, a phase difference (retardation) is made due to a difference in propagation velocity between p-polarized light and s-polarized light. This causes polarized light which has entered the birefringent film base material 102 to optically rotate.

Note that, since a phase difference differs depending on a wavelength, degree of polarization differs depending on the wavelength. Therefore, as illustrated in (a) of FIG. 5, polarized light which has entered the birefringent film base material 102 and has passed through the polarizing plate 103 is divided for each wavelength.

In a case where (i) light is polarized by the polarizing plate 101 provided on an upper surface side of the liquid crystal panel to be linearly-polarized light and then (ii) the linearly-polarized light passes through a birefringent base material such as the birefringent film base material 102, polarization of the linearly-polarized light is eliminated (the linearly-polarized light is depolarized). This generates rainbow unevenness.

Note that, even in the case illustrated in (b) of FIG. 5, rainbow unevenness is generated because polarization is not kept (polarization is eliminated) in the birefringent film base material 102 in a direction different from that of the optical axis of the birefringent film base material 102. That is, rainbow unevenness is generated in a case where the optical axis of the birefringent film base material 102 is not parallel or not perpendicular to the absorption axis of the polarizing plate 101.

The same applies to a case where a touch sensor including the birefringent base material is provided on the liquid crystal panel.

FIG. 6 is an exploded cross-sectional view schematically illustrating the rainbow unevenness generation mechanism.

A display apparatus 2 illustrated in FIG. 6 is the display apparatus 2 illustrated in (b) of FIG. 1. The display apparatus 2 illustrated in FIG. 6 is identical in configuration to the display apparatus 1 illustrated in (a) of FIG. 1 except that, in the display apparatus 2, an optical axis of a birefringent base material 31′ does not extend in a polarization direction of polarized light from a main body 10 of the display apparatus 2. That is, the optical axis of the birefringent base material 31 of the display apparatus 1 illustrated in (a) of FIG. 1 extends in the polarization direction of polarized light from the main body 10 of the display apparatus 1, whereas the optical axis of the birefringent base material 31′ of the display apparatus 2 illustrated in FIG. 6 and (b) of FIG. 1 does not extend in the polarization direction of the polarized light from the main body 10 of the display apparatus 2.

Note that FIG. 6 does not illustrate (i) a configuration of the main body 10 of the display apparatus 2 other than a configuration of a polarizing plate 18, (ii) a circuit section 22, and (iii) drawing wirings 36 and 39.

In a case where depolarization caused by birefringence (as has been described) is taken into account, it can be said that a sensor body 21 illustrated in FIG. 6 is configured so that a protection plate 26 is provided via an adhesive layer 25 on the birefringent base material 31′.

Note that, as has been described, in terms of cost, heat resistance, etc., PET etc. is typically employed as a material for a base material of a sensor film of a touch sensor, and glass is often employed as a material for the protection plate 26.

Therefore, assume in the following description that a PET film is employed as the birefringent base material 31′, an OCAT is employed as the adhesive layer 25, and a glass is employed as the protection plate 26.

FIG. 7 is a graph illustrating (i) a relation between a viewing angle and each of a transmittance of an s-wave (s-polarized light) and a transmittance of a p-wave (p-polarized light) on an interface between the OCAT and the PET film, and (ii) a relation between the viewing angle and each of a transmittance of an s-wave and a transmittance of a p-wave on an interface between the glass and the OCAT. FIG. 8 is a graph illustrating a relation between a viewing angle and each of a transmittance of an s-wave and a transmittance of a p-wave on an interface between the glass and an air layer.

As is clear from FIG. 7, the transmittance of the s-wave and the transmittance of the p-wave on the interface between the OCAT and the PET film, and the transmittance of the s-wave and the transmittance of the p-wave on the interface between the glass and the OCAT are constant regardless of the viewing angle.

On the other hand, as illustrated in FIG. 8, a transmittance of polarized light differs depending on a polarization direction on the interface between the glass and the air layer. That is, in a case of interface reflection between the glass and the air layer, the transmittance of the s-wave and the transmittance of the p-wave differ from each other depending on the viewing angle. Such a difference between the transmittance of the s-wave and the transmittance of the p-wave causes the interface between the glass and the air layer to serve as an analyzer.

Note that, though FIG. 8 illustrates the relation between the viewing angle and each of the transmittance of the s-wave and the transmittance of the p-wave on the interface between the glass and the air layer, the above-described phenomenon is also induced on an interface between the air layer and a layer other than the glass.

Providing a touch panel on an upper polarizing plate of a display panel such as a liquid crystal panel (as has been described) results in sandwiching a birefringent base material between a polarizer and an analyzer. This structure causes rainbow unevenness to be observed in the same manner as a structure illustrated in (a) of FIG. 5.

Note that, as has been described, rainbow unevenness generated by a display apparatus including a touch panel has a close relation with a viewing angle.

The following description will discuss, with reference to FIG. 6, the rainbow unevenness generated by the display apparatus including the touch panel.

Linearly-polarized light which has been emitted via the polarizing plate 18 from the main body 10 of the display apparatus 2 and then has entered the birefringent base material 31′ is in a polarization state due to a birefringent property (wavelength dispersion property) of the birefringent base material 31′, the polarization state differing from one wavelength to another (see FIG. 6). Polarized light in the birefringent base material 31′ is in a polarization state which differs depending on a viewing angle because a retardation differs depending on the viewing angle.

Light which has passed through the birefringent base material 31′ is reflected by the interface between the protection plate 26 and the air layer (air). A reflectivity differs depending on a polarization state. The polarization state differs depending on a wavelength. Therefore, transmitted light is colored.

That is, since degree of polarization differs depending on the wavelength, a difference in the wavelength produces a difference in quantity of light to be reflected. Consequently, a transmission intensity differs from one wavelength to another. As such, polarized light which passes through the birefringent base material 31′ having the birefringent property has the transmission intensity which changes depending on the wavelength due to the wavelength dispersion property of birefringence. The polarized light which has passed through the birefringent base material 31′ is colored.

Since a retardation differs depending on a viewing angle, light which passes through the interface between the polarizing plate 26 and the air layer, the interface serving as an analyzer, has a wavelength which differs depending on the viewing angle. Therefore, the light is recognized as rainbow unevenness (rainbow-like color band).

As has been described, PET is the material for the birefringent base material, and generally has a non-uniform refractive index in a plane. In a case where linearly-polarized light which has entered and passes through the birefringent base material having the non-uniform refractive index is divided into three linearly-polarized beams of light of respective x-axis, y-axis, and z-axis directions, a phase difference (retardation) is made due to birefringence (difference in refractive index).

In a case where the display apparatus 2 is viewed from a direction oblique by an angle θ with respect to a direction perpendicular to a surface of the birefringent base material 31′, a birefringence N_{θ} on, e.g., an x-z plane is represented by Expression 1 below.

$${N}_{θ} = \frac{{n}_{x} {n}_{z}}{\sqrt{{n}_{x}^{2} {cos}^{2} θ + {n}_{z}^{2} {sin}^{2} θ}} \qquad [ Expression 1 ]$$

where (i) nₓ and n_{y} represent a main refractive index of a plane of the birefringent base material 31′, i.e., a main refractive index in a direction parallel to the surface of the birefringent base material 31′ and in a right-and-left direction (x-axis direction) of FIG. 6, and a main refractive index in the direction parallel to the surface of the birefringent base material 31′ and in a direction from a front side of FIG. 6 to a back side of FIG. 6 (y-axis direction), respectively, (ii) n_{z} represents a main refractive index in the direction perpendicular to the surface of the birefringent base material 31′ (z-axis direction), and (iii) θ represents a viewing angle at a certain viewing point P.

A retardation R on the x-z plane is represented by Expression 2 below.

$$R = \frac{{n}_{x} {n}_{z} d}{cos θ \sqrt{{n}_{x}^{2} {cos}^{2} θ + {n}_{z}^{2} {sin}^{2} θ}} \qquad [ Expression 2 ]$$

where d represents a thickness of the birefringent base material 31′.

A phase shift on the x-z plane is represented by Expression 3 below.

$$\frac{{n}_{x} {n}_{z} d}{λ cos θ \sqrt{{n}_{x}^{2} {cos}^{2} θ + {n}_{z}^{2} {sin}^{2} θ}} \qquad [ Expression 3 ]$$

where λ represents a wavelength of light which passes through the interface between the protection plate 26 and the air layer.

Note that, in a case where the birefringent base material 31′ is made from PET (as has been described), the PET has refractive indexes nₓ, n_{y}, and n_{z} of 1.665, 1.661, and 1.492, respectively.

As such, the phase shift differs depending on λ (wavelength) and θ (viewing angle, observation position). Therefore, an intensity of the wavelength of the light which passes through the analyzer (the interface between the protection plate 26 and the air layer) differs depending on the viewing angle.

An example illustrated in FIG. 6 shows that, in a case where the viewing angle is θ₁, blue light (B), green light (G), and red light (R) are less reflected in this order, in other words, transmission intensities thereof increase in this order, whereas in a case where the viewing angle is θ₂, red light (R), blue light (B), and green light (G) are less reflected in this order, in other words, transmission intensities thereof increase in this order.

As illustrated in FIG. 8, in a case of interface reflection, a transmittance of polarized light differs depending on a polarization state of the polarized light.

FIG. 9 is a graph illustrating a relation between a viewing angle and a difference in transmittance between a p-wave and an s-wave.

In a case where the protection plate 26 is made from glass, a color starts to be recognized when the difference in the transmittance between the p-wave and the s-wave (which is set to 1 when it is 100%) reaches approximately 0.1 (i.e., 10%) (the viewing angle θ is approximately 48°) (see FIG. 9). The difference in the transmittance is maximized when the viewing angle θ is approximately 80° (see FIG. 9). At such a maximum difference in transmittance, transmitted light is deep colored.

Thus, rainbow unevenness is visually recognized in the vicinity of a Brewster's angle due to polarization caused by interface reflection.

A Brewster's angle is an incidence angle at which light to be reflected by an interface between substances different in refractive index from each other becomes completely S-polarized light. The Brewster's angle is defined by arctan (n2/n1) where n1 represents a refractive index of one of the substances which one light enters, and n2 represents a refractive index of the other of the substances, the other transmitting light.

At a Brewster's angle, p-polarized light which oscillates in an electric field of a direction parallel to a light entering surface has a reflectivity of 0 (0%), and only s-polarized light which oscillates in an electric field of a direction perpendicular to the light entering surface is reflected.

Therefore, of light which has entered at an angle closer to the Brewster's angle, p-polarized light has an interfacial reflectivity of 0, whereas s-polarized light is reflected. Transmitted light includes more p-polarized light than s-polarized light. That is, linear polarization proceeds. Therefore, rainbow unevenness is remarkably generated, and visually recognized. Note that, in a case where an incidence angle equals to a Brewster's angle, an angle between transmitted light (refracted light) and reflected light is 90°.

Note that, since light in the direction perpendicular to the surface of the birefringent base material 31′ (viewing angle θ is 0°) has no different in transmittance between an s-wave and a p-wave, none of layers that constitute the sensor body 21 serves as an analyzer. Therefore, no rainbow unevenness is observed at the viewing angle θ of 0°.

FIG. 10 is a diagram illustrating a relation among (i) a size of a display surface (display size) of the display apparatus 2 configured as illustrated in FIG. 6, (ii) viewing angles θ₁ through θ₃ and (iii) a viewing distance L. Note that FIG. 10 illustrates a case where the display surface of the display apparatus 2 which is horizontally placed is viewed from obliquely above.

In FIG. 10 where a display screen of the display apparatus 2 is observed obliquely, (i) θ₁ represents a central viewing angle (display central viewing angle) at a center point p1 of the display screen, (ii) θ₂ represents a viewing angle at a point p2 on a center line of the display screen which point p2 is present on an edge of the display screen, the edge being closer to an observer, (iii) 03 represents a viewing angle at a point p3 on the center line of the display screen which point p3 is present on another edge of the display screen, the another edge being more distant from the observer, and (iv) L represents a viewing distance at the central viewing angle θ₁ (i.e., a distance between the center point p1 and a viewing point P of the observer). FIG. 11 is a graph illustrating a relation between a viewing angle range (from θ₂ to θ₃) and a display size in a case where the viewing distance L is 40 cm and the central viewing angle θ₁ is 30°.

As illustrated in FIG. 11, in a case where the display apparatus 2 having a 15-inch display size is observed at the viewing distance L of 40 cm and the central viewing angle θ₁ of 30°, the viewing angle at the edge of the display screen is approximately 48° at which (i) an observer starts recognizing colored transmitted light and (ii) a difference in transmittance is approximately 0.1. Therefore, in a case where a display apparatus 2 whose display size is not smaller than 15 inches is viewed, rainbow unevenness is constantly observed.

<Rainbow-Like Color Band (Rainbow Unevenness) which is Allowable During Use of Display Device, and Measures to be Taken Against Rainbow-Like Color Band (Rainbow Unevenness)>

Rainbow unevenness remarkably impairs performance of a display apparatus. It is therefore necessary to eliminate the rainbow unevenness.

Note, however, that, strictly speaking, a rainbow-like color band which causes a problem when a display apparatus including a touch panel is actually used needs only to be prevented.

Specifically, a display apparatus including a touch panel, employed as, e.g., a digital signage or an electronic blackboard, is required to prevent a rainbow-like color band from being generated when the display apparatus is viewed from a traverse direction. In order that the display apparatus does not generate the rainbow-like color band when the display apparatus is viewed from the traverse direction, an absorption axis of a polarizing plate of a main body of the display apparatus and optical axes of a birefringent base material are adjusted.

That is, in a case where the display apparatus (e.g., the digital signage or the electronic blackboard) is stood so that shorter sides of an oblong screen of the display apparatus are upper and lower sides of the display device, the display apparatus is hardly viewed from obliquely above or from obliquely below. Even if the display apparatus generates a rainbow-like color band in this obliquely upward direction or in this obliquely downward direction, the rainbow-like color band does not disturb viewing of the display apparatus.

In order that the display apparatus does not generate the rainbow-like color band when the display apparatus is viewed from the traverse direction, (i) the absorption axis of the polarizing plate of the main body of the display apparatus should be parallel to a longitudinal direction (x direction) or a traverse direction (y direction) and (ii) three optical axes of the birefringent base material should be parallel or perpendicular to a polarization direction of light.

Assume here that (i) the longitudinal direction (x direction) and the traverse direction (y direction) are based on an x-y planar surface that is a surface parallel to a display surface of the display apparatus including the touch panel and (ii) the traverse direction (horizontal and traverse direction) from which the display apparatus, which is stood so that the shorter sides of the oblong screen of the display apparatus are the upper and lower sides of the display device, is viewed is the y direction.

In a case where the absorption axis, of the polarizing plate, parallel to the longitudinal direction (x direction) or the traverse direction (y direction) of the display apparatus is parallel or perpendicular to the optical axes of the birefringent base material, linearly-polarized light that enters the birefringent base material via the polarizing plate does not cause a phase shift in the birefringent base material, the phase shift differing from one wavelength from another.

On the other hand, in a case where the absorption axis, of the polarizing plate, parallel to the longitudinal direction (x direction) or the traverse direction (y direction) of the display apparatus is neither parallel nor perpendicular to the optical axes of the birefringent base material, the polarization direction of the light is subjected to vector resolution along the optical axes. Light subjected to the vector resolution makes a phase difference that differs from one wavelength from another. A rainbow-like color band is generated due to interface reflection on an interface with air.

The following description will discuss, with reference to FIGS. 12 through 14, (i) generation of a rainbow-like color band which is allowable during use of the display apparatus and (ii) an allowable angle between an optical axis of a birefringent base material 31 and a polarization direction of polarized light from a main body 10 of a display apparatus.

FIG. 12 is an explanatory view explaining a relation between the optical axis of the birefringent base material 31′ and the absorption axis of the main body 10 of the display apparatus 2 (see (b) of FIG. 1 and FIG. 6) including the display panel. FIG. 13 is an explanatory view emphatically illustrating a difference in direction between the optical axis of the birefringent base material 31′ and the absorption axis of the main body 10 of the display apparatus 2.

FIG. 14 is a diagram illustrating dependency, on an angle between an optical axis of a birefringent base material and an absorption axis of a polarizing plate, of energy of transmitted light of each polarization direction on an interface between a protection layer and air.

As illustrated in FIGS. 12 and 13, the absorption axis of the main body 10 of the display apparatus 2, i.e., the absorption axis of the polarizing plate 18 extends in the y direction. On the other hand, an optical axis nx and an optical axis ny of the birefringent base material 31′ extend neither in the x direction nor in the y-axis direction. An angle between the optical axis ny of the birefringent base material 31′ and the absorption axis of the polarizing plate 18 (y direction) is Φ.

The following can be said in a case where (i) the absorption axis extends in in the y-axis direction, a direction in which light oscillates in an electric field is the x-axis direction, and the angle between the absorption axis and the optical axis is Φ (see FIG. 13), and (ii) an amplitude at which the light oscillates in the electric field is A, a polarization direction is divided in a direction of the optical axis and further divided in the direction in which the light oscillates in the electric field.

First, in a case where the polarization direction is divided in the direction of the optical axis, i.e., in an nx direction and in an ny direction, nx:A sin Φ and ny:−A cos Φ are obtained.

Then, in a case where each of polarized light of the nx direction and polarized light of the ny direction is divided in the direction in which the light oscillates in the electric field, i.e., in the x direction and the y direction, the nx:A sin Φ can be divided into x:A sin² Φ and y:A sin Φ cos Φ, whereas the ny:−A cos Φ can be divided into x:A cos² Φ and y:−A sin Φ cos Φ.

A phase shift to be caused differs depending on a thickness of the birefringent base material 31′. In a case where a phase shift is caused by half of a wavelength between an nx-axis direction and an nz-axis direction in the birefringent base material 31′, an amplitude of a component of a polarization direction of the x-axis direction, and an amplitude of a component of a polarization direction of the y-axis direction are as follows.

That is, for p-polarized light, x:A(sin² Φ−cos² Φ)=−A cos 2Φ, whereas, for s-polarized light, y:2A sin Φ cos Φ=A sin 2Φ. Since energy of light corresponds to the square of an amplitude of the light, dependency, on the angle Φ between the optical axis of the birefringent base material and the absorption axis of the polarizing plate, of energy of transmitted light of each polarization direction on an interface between a protection layer and air can be shown in FIG. 14.

Note here that, in a case where a protection layer 26 is made from glass, a polarization effect due to interface reflection which polarization effect causes a rainbow-like color band is maximized at a viewing angle of approximately 78° (see FIG. 8). At this viewing angle, a reflectivity of an s-wave is 50%. As the reflectivity of the s-wave decreases, an effect of the rainbow-like color band is reduced.

As has been described, colored transmitted light starts to be recognized at a viewing angle of approximately 48° at which a difference in transmittance is approximately 10%. In this case, the reflectivity of the s-wave is 12%.

That is, the angle between the absorption axis and the optical axis is allowed to be made in a case where (i) a phase shift is caused by half of a wavelength due to birefringence (maximum phase shift) and (ii) the reflectivity of the s-wave is not more than 12% at the viewing angle of 78° at which a maximum difference in transmittance is maximized.

FIG. 14 illustrates the dependency, on the angle between the absorption axis and the optical axis, of the energy of the transmitted light of the each polarization direction. In FIG. 14, the vertical axis represents the ratio of an s-wave component to a p-wave component, and the horizontal axis represents the angle t between the optical axis ny of the birefringent base material 31′ and the absorption axis (y direction) of the polarizing plate 18 (see FIG. 13).

Note here that the reflectivity 12% at which “a transmittance of the interface between the protection layer and air is approximately 10%” represents the reflectivity of only the s-wave. In a case where light includes an s-wave and a p-wave half, the reflectivity represented by a “transmittance of the interface between the protection layer and air” is half of the reflectivity of the s-wave. That is, since the reflectivity of only the s-wave is 12%, 6% of the whole quantity of light including the s-wave and the p-wave reflects as the s-wave. Therefore, in order to prevent rainbow unevenness, not more than 6% of the whole quantity of light including the s-wave and the p-wave should reflect as the s-wave.

As such, since the reflectivity of the s-wave of the whole s-wave is 50% at an incidence angle of 78°, the ratio of reflected light of the s-wave is 6% with respect to the total quantity of light that includes the s-wave by 12%. In this case, no rainbow unevenness is visually recognized. The angle between the absorption axis and the optical axis at which angle the light includes the s-wave by 12% is 11°. In a case where the angle between the absorption axis and the optical axis is not more than 11°, rainbow unevenness is prevented from being visually recognized.

It is found from FIG. 14 that light includes an s-wave by not more than 12% in a case where the angle between the absorption axis and the optical axis is not more than 11°.

Therefore, it is possible to prevent rainbow unevenness from being generated when a display apparatus is viewed from a traverse direction, by (i) causing an absorption axis of a polarizing plate to be parallel to a longitudinal direction (x direction) or a traverse direction (y direction) of the display apparatus and (ii) reducing, to not more than 11°, an angle between the absorption axis of the polarizing plate and an optical axis of each birefringent base material.

Note that, as is clear from the above description, a reflectivity of and a transmittance of an interface between a protection layer and air vary depending on, e.g., a material for the protection layer. Accordingly, an allowable range of the angle between the absorption axis of the polarizing plate and the optical axis of the each birefringent base material varies depending on the material for the protection layer. It goes without saying that the allowable range can be found as appropriate according to, e.g., the material for the protection layer.

Note here that examples of a material mainly employed as the material for the protection layer include an acrylic resin and polycarbonate in addition to the above-described glass. The acrylic resin and polycarbonate have respective refractive indices substantially equal to that of the glass, i.e., approximately 1.5.

Therefore, the above description of the angle between the absorption axis of the polarizing plate and the optical axis of the each birefringent base material is applicable to a case where a protection layer made from the acrylic resin or polycarbonate is used instead of the protection layer made from the glass, though the above has described the allowable range of the angle between the absorption axis of the polarizing plate and the optical axis of the each birefringent base material in a case where the glass, from which a protection layer is typically made, is employed as the material for the protection layer.

That is, a display apparatus including a protection layer made from one of the glass, the acrylic resin, and the polycarbonate which are generally employed as a material for the protection layer can prevent rainbow unevenness from being generated when the display apparatus is viewed from a traverse direction, by (i) causing an absorption axis of a polarizing plate to be parallel to a longitudinal direction (x direction) or a traverse direction (y direction) of the display apparatus and (ii) reducing, to not more than 11°, an angle between the absorption axis of the polarizing plate and an optical axis of each birefringent base material.

The present invention (i) causes an absorption axis of a polarizing plate of a main body of a display apparatus to be parallel to a longitudinal direction (x direction) or a traverse direction (y direction) of the display apparatus and (ii) controls an angle between the absorption axis of the polarizing plate and an optical axis of a birefringent base material.

An allowable range of the angle between the absorption axis of the polarizing plate and the optical axis of the birefringent base material needs only to allow a reflectivity of an s-wave to be controlled so that a difference in transmittance between the s-wave and a p-wave on an interface between a protection layer and air is not more than 10% even in a case where, at an angle where the difference in transmittance is maximized, a phase shift of transmitted light is caused by half of a wavelength due to the birefringent base material (maximum phase shift).

Needless to say, a display apparatus including a touch panel, of the present invention, may include a plurality of birefringent base materials to be included in the touch panel. In a case where the display apparatus includes the plurality of birefringent base materials, an angle between an optical axis of each of the plurality of birefringent base materials and an absorption axis of a polarizing plate of a main body of the display apparatus needs only to fall within an allowable range of the angle which allowable range is determined in accordance with a material for a protection layer.

As has been described, rainbow unevenness is caused by (i) a change in polarization state that differs from one wavelength to another, the change being caused by a birefringent base material, and (ii) dependency, on the polarization state, of interface reflection on an interface with an air layer.

Specifically, rainbow unevenness is generated due to (i) a phase shift of linearly-polarized light due to a birefringent property of a birefringent base material 31 and (ii) a polarization effect. Rainbow unevenness is generated, particularly by a polarization effect of interface reflection in the vicinity of a Brewster's angle.

Note that, even if light emitted from a main body 10 of a display apparatus is converted into circularly-polarized light, linear polarization of the circularly-polarized light proceeds due to interface reflection on an interface between a birefringent base material and a layer which is adjacent to the birefringent base material and made from a material different from that for the birefringent base material. Therefore, even if the light emitted from the main body 10 of the display apparatus is converted into the circularly-polarized light, it is not possible to prevent rainbow unevenness from being generated, particularly in the vicinity of a Brewster's angle.

According to the present embodiment, however, it is possible to prevent such generation of the rainbow unevenness.

That is, one factor that causes rainbow unevenness is a phase shift of linearly-polarized light due to a birefringent property of a birefringent base material. It is therefore possible to prevent the rainbow unevenness by preventing the phase shift that differs from one wavelength from another of the linearly-polarized light in the birefringent base material.

It is possible to reduce the rainbow unevenness by, as illustrated in (a) of FIG. 1, (i) extending the optical axis of the birefringent base material 31 in the polarization direction of the polarizing plate 18 of the main body 10 of the display apparatus from which main body 10 linearly-polarized light enters the birefringent base material 31, i.e., (ii) causing the optical axis to be parallel or perpendicular to the polarization direction.

As has been described, colored light starts to be recognized when a difference in transmittance between an s-wave and a p-wave is approximately 0.1 (10%). When the difference is 0.1 (10%), a reflectivity of the s-wave on an interface between the protection plate 26 and air is 12%.

Therefore, the optical axis of the birefringent base material 31 should extend in the polarization direction of the polarizing plate 18 of the main body 10 of the display apparatus so that the reflectivity of the s-wave on the interface between the protection plate 26 and air is not more than 12%.

A rainbow-like color band is visually recognized most remarkably at a viewing angle of 78°.

Therefore, the optical axis of the birefringent base material 31 should extend in the polarization direction of the polarizing plate 18 of the main body 10 of the display apparatus so that the reflectivity of the s-wave is not more than 12% at the viewing angle of 78°.

As has been described with reference to FIGS. 12 through 15, rainbow unevenness is not visually recognized in a case where the angle between the optical axis of the birefringent base material 31 and the polarization direction of the polarizing plate 18 of the main body 10 of the display apparatus falls within 11°.

Note that FIG. 2 illustrates a case where the sensor body 21 has a touch sensor structure in which the double-side sensor film 30 is employed as a sensor film. However, the present embodiment is not limited to this case.

The following description will discuss, with reference to (a) through (e) of FIG. 15 through (a) through (e) of FIG. 20, (i) modifications of the touch sensor structure of the sensor body 21 and (ii) a method of forming a modified touch sensor structure.

Note that a difference from the method illustrated in (a) through (e) of FIG. 4 will be described below.

<Modification 1 of Touch Sensor Structure>

(a) of FIG. 15 through (e) of FIG. 15 are cross-sectional views illustrating, in order of step, a method of producing a sensor body 21 of a touch panel 20. Note that (a) of FIG. 15 through (e) of FIG. 15 do not illustrate a Y electrode pattern 32, an X electrode pattern 33, and drawing wirings 36 and 39.

The sensor body 21 of Modification 1 includes, instead of the protection film 23, the adhesive layer 24, and the double-side sensor film 30 which are illustrated in (e) of FIG. 4, (i) a single-side sensor film 81 in which a Y electrode pattern 32 (not illustrated) is provided on one surface of a first birefringent base material 31, (ii) an adhesive layer 82, and (iii) a single-side sensor film 83 in which an X electrode pattern 33 (not illustrated) is provided on one surface of a second birefringent base material 31 so that the single-side sensor film 81, the adhesive layer 82, and the single-side sensor film 83 are stacked in this order from below (see (e) of FIG. 15).

The sensor body 21 having the above configuration is produced, for example, as follows.

First, similar to (a) of FIG. 4, the Y electrode pattern 32 (not illustrated) is formed on the one surface of the first birefringent base material 31, so that the single-side sensor film 81 including the Y electrode pattern 32 is formed (see (a) of FIG. 15).

Subsequently, the adhesive layer 82 such as an OCAT is formed on a sensor surface 81a of the single-side sensor film 81 (i.e., a surface of the single-side sensor film 81 on which surface the Y electrode pattern 32 is formed) so that the sensor surface 81a is an upper surface of the single-side sensor film 81 (see (b) of FIG. 15).

On the other hand, similar to (a) of FIG. 4, the X electrode pattern 33 (not illustrated) is formed on the one surface of the second birefringent base material 31, so that the single-side sensor film 83 including the X electrode pattern 33 is formed (see (c) of FIG. 15).

Thereafter, the single-side sensor film 81 and the single-side sensor film 83 are combined with each other via the adhesive layer 82 so that (i) a sensor surface 83a of the single-side sensor film 83 (i.e., a surface of the single-side sensor film 83 on which surface the X electrode pattern 33 is formed) is an upper surface of the single-side sensor film 83 (see (c) of FIG. 15) and (ii), similar to the double-side sensor film 30, when viewed from above, each Y electrode 34 (not illustrated) is located between corresponding two adjacent X electrodes 37, and each X electrode 37 (not illustrated) is located between corresponding two adjacent Y electrodes 34.

Subsequently, an adhesive layer 25 such as an OCAT is formed on the sensor surface 83a of the single-side sensor film 83 (see (d) of FIG. 15). Then, a protection plate 26 is adhered via the adhesive layer 25 to the sensor surface 83a of the single-side sensor film 83 (see (e) of FIG. 15).

<Modification 2 of Touch Sensor Structure>

(a) of FIG. 16 through (g) of FIG. 16 are cross-sectional views illustrating, in order of step, a method of producing a sensor body 21 of a touch panel 20. Note that (a) of FIG. 16 through (g) of FIG. 16 do not illustrate a Y electrode pattern 32, an X electrode pattern 33, and drawing wirings 36 and 39, either.

The sensor body 21 of Modification 2 includes, instead of the double-side sensor film 30 illustrated in (e) of FIG. 4, (i) a single-side sensor film 81 including a Y electrode pattern 32 (not illustrated), (ii) an adhesive layer 82, and (iii) a single-side sensor film 83 including an X electrode pattern 33 (not illustrated). The single-side sensor film 81, the adhesive layer 82, and the single-side sensor film 83 are stacked in this order from below so that (i) a sensor surface 81a of the single-side sensor film 81 is a lower surface of the single-side sensor film 81 and (ii) a sensor surface 83a of the single-side sensor film 83 is a lower surface of the single-side sensor film 83 (see (h) of FIG. 16).

The sensor body 21 having the above configuration is produced, for example, as follows.

First, similar to (a) of FIG. 4, the X electrode pattern 33 (not illustrated) is formed on one surface of a first birefringent base material 31, so that the single-side sensor film 83 including the X electrode pattern 33 is formed (see (a) of FIG. 16).

Subsequently, the adhesive layer 82 such as an OCAT is formed on the sensor surface 83a that is the lower surface of the single-side sensor film 83 (see (b) of FIG. 16).

On the other hand, similar to (a) of FIG. 4, the Y electrode pattern 32 (not illustrated) is formed on one surface of a second birefringent base material 31, so that the single-side sensor film 81 including the Y electrode pattern 32 is formed (see (c) of FIG. 16).

Thereafter, the single-side sensor film 83 and the single-side sensor film 81 are combined with each other via the adhesive layer 82 so that (i) the sensor surface 81a of the single-side sensor film 81 is the lower surface of the single-side sensor film 81 (see (c) of FIG. 16) and (ii), similar to the double-side sensor film 30, when viewed from above, each Y electrode 34 (not illustrated) is located between corresponding two adjacent X electrodes 37, and each X electrode 37 (not illustrated) is located between corresponding two adjacent Y electrodes 34.

Subsequently, an adhesive layer 24 such as an OCAT is formed on the sensor surface 81a of the single-side sensor film 81 (see (d) of FIG. 16). Then, a protection film 23 is adhered via the adhesive layer 24 to the sensor surface 81a of the single-side sensor film 81 (see (e) of FIG. 16).

Thereafter, an adhesive layer 25 such as an OCAT is formed on an upper surface side of the single-side sensor film 83 provided on an upper surface side of the sensor body 21, i.e., above the sensor surface 83a of the single-side sensor film 83 (see (f) of FIG. 16). Then, a protection plate 26 is adhered via the adhesive layer 25 above the sensor surface 83a of the single-side sensor film 83 (see (g) of FIG. 16).

<Modification 3 of Touch Sensor Structure>

(a) of FIG. 17 through (e) of FIG. 17 are cross-sectional views illustrating, in order of step, a method of producing a sensor body 21 of a touch panel 20. Note that (a) of FIG. 17 through (e) of FIG. 17 do not illustrate a Y electrode pattern 32, an X electrode pattern 33, and drawing wirings 36 and 39, either. FIG. 18 is a plain view illustrating pattern shapes of the Y electrode pattern 32 and the X electrode pattern 33 which are included in a single-side sensor film 83.

The sensor body 21 of Modification 3 includes, instead of the double-side sensor film 30 illustrated in (e) of FIG. 4, a single-side sensor film 84 having one surface on which an Y electrode pattern 32 (not illustrated) and an X electrode pattern 33 (not illustrated) are provided so that a sensor surface 84a of the single-side sensor film 84 (i.e., a surface of the single-side sensor film 84 on which surface the Y electrode pattern 32 and the X electrode pattern 33 are formed) is a lower surface of the single-side sensor film 84 (see (e) of FIG. 17), the single-side sensor film 84 being provided in an order illustrated in (e) of FIG. 17.

The sensor body 21 having the above configuration is produced, for example, as follows.

First, Y electrodes 34 and X electrodes 37 are arranged on one surface of a birefringent base material 31 so that (i) each of the Y electrodes 34 is located between corresponding two adjacent ones of the X electrodes 37 and (ii) each of the X electrodes 37 is located between corresponding two adjacent ones of the Y electrodes 34 (see FIG. 18). This forms the single-side sensor film 84 having the one surface on which the Y electrode pattern 32 and the X electrode pattern 33 are provided (see (a) of FIG. 17).

In a case where the Y electrode pattern 32 and the X electrode pattern 33 are provided on the one surface of the single-side sensor film 84, a space 85 is formed between the Y electrodes 34 and the X electrodes 37 (see FIG. 18) so that the Y electrodes 34 are not electrically connected to the X electrodes 37.

Note that FIG. 18 illustrates a case where each connection line 34a serving as a jumper makes a bridge connection between corresponding two Y electrodes 34 of a Y electrode column 35 so as to cross a corresponding connection line 37a which connects two X electrodes 37 of an X electrode row 38. Alternatively, each connection line 37a may have a jumper structure in which the each connection line 37a makes a bridge connection between corresponding two X electrodes 37 so as to cross a corresponding connection line 34a. As such, the jumper etc. makes a bridge connection between ones of the Y electrodes 34 and the X electrodes 37 so as to cross a direction in which the others of the Y electrodes 34 and the X electrodes 37 are arranged. This makes it possible to form the Y electrode pattern 32 and the X electrode pattern in an identical planar surface without electrically connecting the Y electrodes 34 and the X electrodes 37.

Note that, in this case, it is preferable to provide an electrically-insulating layer between the each connection line 34a and the corresponding connection line 37a (i.e., when viewed from above, between the each connection line 34a and the corresponding connection line 37a in a part where the each connection line 34a and the corresponding connection line 37a intersect with each other). A material for the electrically-insulating layer is not particularly limited. Various publicly-known electrically-insulating materials can be employed as the material for the electrically-insulating layer.

An electrically-insulating layer is not necessarily provided in the space 85. The space 85 may be filled with an adhesive layer 24, depending on a material for the adhesive layer 24 or a method of forming the adhesive layer 24.

Note that a size of the space 85 (i.e., a distance between the Y electrodes 34 and the X electrodes 37) is not particularly limited provided that the space 85 can keep electrical insulation between the Y electrodes 34 and the X electrodes 37.

As illustrated in (b) of FIG. 17, the adhesive layer 24 such as an OCAT is formed on the sensor surface 84a that is the lower surface of the single-side sensor film 84. Then, a protection film 23 is adhered via the adhesive layer 24 to the sensor surface 84a of the single-side sensor film 84 (see (c) of FIG. 17).

Subsequently, an adhesive layer 25 such as an OCAT is formed on an upper surface side of the single-side sensor film 84, i.e., on a surface of the single-side sensor film 84 which surface is opposite to the sensor surface 84a (see (d) of FIG. 17). Then, a protection plate 26 is adhered via the adhesive layer 25 on the upper surface side of the single-side sensor film 84 (see (e) of FIG. 19).

<Modification 4 of Touch Sensor Structure>

(a) of FIG. 19 through (c) of FIG. 19 are cross-sectional views illustrating, in order of step, a method of producing a sensor body 21 of a touch panel 20. Note that (a) of FIG. 19 through (c) of FIG. 19 do not illustrate a Y electrode pattern 32, an X electrode pattern 33, and drawing wirings 36 and 39, either.

The sensor body 21 of Modification 4 includes (i) a single-side sensor film 84 having one surface on which a Y electrode pattern 32 (not illustrated) and an X electrode pattern 33 (not illustrated) are provided, (ii) an adhesive layer 25, and (iii) a protection plate 26 in this order from below so that a sensor surface 84a of the single-side sensor film 84 is an upper surface of the single-side sensor film 84 (see (c) of FIG. 19). Since the single-side sensor film 84 is provided so that the sensor surface 84a of the single-side sensor film 84 is the upper surface of the single-side sensor film 84, the sensor body 21 does not include an adhesive layer 24 and a protection film 23.

The sensor body 21 having the above configuration is produced, for example, as follows.

First, similar to (a) of FIG. 17, the single-side sensor film 84, having the one surface on which the Y electrode pattern 32 and the X electrode pattern 33 are provided, is formed (see (a) of FIG. 19).

Subsequently, the adhesive layer 25 such as an OCAT is formed on the sensor surface 84a that is the upper surface of the single-side sensor film 84 (see (b) of FIG. 19). Then, the protection plate 26 is adhered via the adhesive layer 25 to the upper surface of the single-side sensor film 84 (see (c) of FIG. 19).

<Modification 5 of Touch Sensor Structure>

(a) of FIG. 20 through (e) of FIG. 20 are cross-sectional views illustrating, in order of step, a method of producing a sensor body 21 of a touch panel 20. Note that (a) of FIG. 20 through (e) of FIG. 20 do not illustrate a Y electrode pattern 32, an X electrode pattern 33, and drawing wirings 36 and 39, either.

Unlike the sensor body 21 illustrated in (g) of FIG. 16, the sensor body 21 of Modification 5 is configured so that (i) neither an adhesive layer 25 nor a protection plate 26 is provided on an upper surface side of a single-side sensor film 83 (see (e) of FIG. 20) and (ii) an antireflection layer 28 is formed on the upper surface side via an adhesive layer 27.

Steps illustrated in (a) of FIG. 20 through (e) of FIG. 20 are identical to those illustrated in (a) of FIG. 16 through (e) of FIG. 16.

According to the sensor body 21 of Modification 5, a protection film 23 is adhered via an adhesive layer 24 to a sensor surface 81a of a single-side sensor film 81 (see (e) of FIG. 16). In FIG. 16, after (e) of FIG. 16, the adhesive layer 25 such as an OCAT is formed on the upper surface side of the single-side sensor film 83. Then, the protection plate 26 is adhered via the adhesive layer 25 above the sensor surface 83a of the single-side sensor film 83.

Note, however, that FIG. 20 illustrates a case where the sensor body 21 has a top surface that is an upper surface of the single-side sensor film 83.

As such, the touch panel 20 (sensor body 21) of the present embodiment may include a plurality of birefringent base materials 31.

<Modification of Main Body 10 of Display Apparatus>

The present embodiment has described a case where a liquid crystal display apparatus is employed as a main body 10 of a display apparatus which main body 10 emits polarized light. However, the present embodiment is not limited to this case. Various display apparatuses including a polarizing plate (polarizer) can be employed as the main body 10. An Example of the display apparatuses is a display apparatus in which a dielectric liquid is employed as a display medium, whereas the liquid crystal display apparatus employs liquid crystal as a display medium.

<Modification of Detection Method of Touch Panel 20>

The present embodiment has described a case where an electrostatic capacitive touch panel is employed as a touch panel 20. However, a detection method itself of the touch panel 20 is not particularly limited. The present embodiment is applicable to a touch panel in general having a display region where a birefringent base material is employed as a base material.

<Modification of Touch Sensor Structure of Double-Side Sensor Film 30 Etc.>

The present embodiment has described a case where a double-side sensor film 30 is configured so that (i) a Y electrode pattern 32 is provided on a lower surface side of a birefringent base material 31 and (ii) an X electrode pattern 33 is provided on an upper surface side of the birefringent base material 31. Alternatively, the double-side sensor film 30 may be configured so that (i) the Y electrode pattern 32 is provided on the upper surface side of the birefringent base material 31 and (ii) the X electrode pattern 33 is provided on the lower surface side of the birefringent base material 31.

Similarly, the Y electrode pattern 32 and the X electrode pattern 33 may be stacked in an opposite order in the above-described other modifications of the touch sensor structure too.

<Modification of Protection Layer>

The present embodiment has described a case where a plastic film or plastic substrate, and a glass substrate etc. are combined with a double-side sensor film 30 etc. via adhesive layers 25 and 32 so that protection layers (a protection film 23 and a protection plate 26) are adhered to the double-side sensor film 30.

However, the present embodiment is not limited to this case. It is possible to form the protection layers on the double-side sensor film 30, for example, by (i) laminating a plastic film on the double-side sensor film 30 or (ii) applying a material for the protection layers onto the double-side sensor film 30.

That is, these protection layers may be integrated with the double-side sensor film 30 by combining these protection layers with the double-side sensor film 30 via adhesive layers. Alternatively, these protection layers may be integrated with the double-side sensor film 30 by directly stacking these protection layers on the double-side sensor film 30.

<Touch Panel on which Surface Reflection Plate is Provided>

For example, an adhesive layer 27 such as an OCAT may be formed on a protection plate 26, and then, an antireflection layer 28 (not illustrated) such as an AR film may be adhered via the adhesive layer 27 to the protection plate 26 so that a surface of the antireflection layer 28 is a top surface of a touch panel 20 (a top surface of a sensor body 21).

As disclosed by the inventors of the present invention in Japanese Patent Application Tokugan No. 2012-125459 (filed on May 31, 2012), it is possible to further prevent generation of a rainbow-like color band by providing the antireflection layer 28 above the protection plate 26.

The antireflection layer 28 used in the present embodiment is a layer which reduces reflection of polarized light which has exited from a display panel 12. The antireflection layer 28 reduces, for example, reflection of polarized light which has exited from the display panel 12 and has passed through a birefringent base material 31, the polarized light being reflected (i) on an interface having a polarization effect and (ii) at a viewing angle at which a different in transmittance between an s-wave and a p-wave on the interface is not less than 10%.

That is, by being provided on a first surface of the touch panel 20 which first surface is opposite to a second surface of the touch panel 20 which second surface faces the display panel 12, the antireflection layer 28 reduces reflection of the polarized light which is reflected on the first surface toward the display panel 12 at the viewing angle at which the difference in the transmittance between the s-wave and the p-wave is not less than 10%.

Examples of the antireflection layer 28 include (i) an antireflection layer made from a dielectric material and (ii) an antireflection layer having a minute convexoconcave structure as a minute structure.

Preferable and further specific examples of the antireflection layer 28 include (i) a multilayer AR (Anti-Reflective) film which prevents reflection of light by means of interference of the light and (ii) a non-reflection film which has curved protrusions on its surface and a refractive index which consecutively changes in a direction of a thickness of the film, i.e., a non-reflection film having a so-called moth-eye structure.

An example of the AR film is a film in which (i) a plastic film made from, e.g., TAC or PET is employed as a base material and (ii) a plurality of layers of dielectrics different in refractive index from each other are stacked.

A publicly-known AR film can be employed as the film. An example of the publicly-known AR film is a film in which (i) a hard coat layer is formed on a base material and (ii) a high-refractive layer (containing an ionic liquid) and a low-refractive layer (containing hollow minute silica particles) are alternately stacked on the hard coat layer (see, for example, Patent Literature 3).

An example of the antireflection layer having the minute convexoconcave structure is a film having a surface that has a minute convexoconcave pattern whose convexoconcave cycle is controlled to be not more than a wavelength of visible light.

For example, a publicly-known film having a moth-eye structure can be employed as the film. The film can be formed, for example, by building, with use of a metal mold etc., a minute structure of a thermosetting resin or a photo-curable resin on a base material of the film (see, for example, Patent Literature 4).

It is possible to form the antireflection layer 28 on the protection plate 26 via the adhesive layer 27 (see FIG. 1), for example, by combining the antireflection layer 28 with the protection plate 26 via an adhesive material such as an OCAT (Optical Clear Adhesive Tape).

Note, however, that the adhesive layer 27 does not need to be essentially provided between the antireflection layer 28 and the protection plate 26, though the above has described a case where the adhesive layer 27 is provided between the antireflection layer 28 and the protection plate 26. The antireflection layer 28 may be provided directly on the protection plate 26 by means of lamination, printing, etc.

Note also that the antireflection layer 28 does not need to be essentially provided above the protection plate 26, though the above has described a case where the antireflection layer 28 is provided above the protection plate 26. The antireflection layer 28 may be directly formed on an upper surface of the protection plate 26 by minutely processing the upper surface of the protection plate 26. In other words, the antireflection layer 28 may also serve as the protection plate 26.

Note that, in a case where the AR film is employed as the antireflection layer 28 (as has been described), a commercially-available antireflection film can be employed as the AR film.

On the other hand, it is possible to optimally design the antireflection layer 28 by forming the antireflection layer 28 so as to eliminate reflected light at a viewing angle at which rainbow unevenness is easily generated.

In a case where the antireflection layer 28 is optimally designed, the antireflection layer 28 is more desirably a layer stack including a multilayer film in which a plurality of dielectric layers different in refractive index from each other are stacked, in terms of an antireflection effect and a design characteristic.

<Modification of Birefringent Base Material>

The above has described a case where a birefringent base material 31 is made from PET. A birefringent base material of a display apparatus including a touch panel, of the present invention, is not limited to this case. For example, a wavelength plate in which an optical axis is controlled may be employed as the birefringent base material 31.

The present invention prevents generation of a rainbow-like color band by controlling an optical axis of a birefringent base material that is a base material of a touch sensor to be parallel or perpendicular to a polarization direction of polarized light from a main body of a display apparatus. A material for the birefringent base material etc. can be variously changed.

As has been described, the display apparatus 1 includes (i) the polarizing plate provided so that a surface of the polarizing plate is a surface of the main body 10 of the display apparatus 1 and (ii) the touch panel 20 which includes the birefringent base material 31 whose optical axis is parallel or perpendicular to the absorption axis of the polarizing plate.

This configuration allows the display apparatus 1 to prevent rainbow unevenness from being caused by (i) a change in polarization state of polarized light emitted from the main body 10 and (ii) a polarization effect of interface reflection on an interface between an air layer and the touch panel 20 including the birefringent base material 31 and being provided on a front surface of the main body 10.

As such, a display apparatus of the present invention is configured to a display apparatus, including: a display panel from which polarized light exits; and a touch panel including at least one birefringent base material that has optical axes in respective two directions in a plane, the polarized light which has exited from the display panel entering the at least one birefringent base material, and one of the optical axes of the at least one birefringent base material being parallel or perpendicular to a polarization direction of the polarized light which enters the at least one birefringent base material.

As has been described, the inventors of the present invention found that, in a case where a touch panel including a birefringent base material is provided on a display panel, such as a liquid crystal panel, from which polarized light exits, rainbow unevenness (rainbow-like color band) is visually recognized by a viewer even without polarized glasses on at a certain viewing angle, particularly at a viewing angle at which a difference in transmittance between an s-wave and a p-wave on an interface of the touch panel which interface has a polarization effect is not less than 10%.

As a result of a further study, the inventors of the present invention found that such rainbow unevenness is caused due to (i) a change in polarization state that differs from one wavelength to another, the change being caused by the birefringent base material, and (ii) dependency, on the polarization state, of interface reflection on an interface between an air layer and a surface of the touch panel, e.g., a cover glass. The inventors of the present invention found that, specifically, the rainbow unevenness is generated by (i) a phase shift of linearly-polarized light due to a birefringent property of the birefringent base material and (ii) the polarization effect.

As such, one factor that causes the rainbow unevenness is the phase shift of the linearly-polarized light due to the birefringent property of the birefringent base material. It is therefore possible to prevent the phase shift of the linearly-polarized light and the rainbow unevenness by controlling an optical axis of the birefringent base material and a polarization direction of a polarizing plate of the display panel from which the linearly-polarized light enters the birefringent base material, i.e., by causing the optical axis to be parallel or perpendicular to the polarization direction.

A display apparatus including a touch panel, of the present invention, is configured to be a display apparatus, including:

(1) a display panel including a polarizing plate so that a surface of the polarizing plate is a surface of the display panel; and

(2) a touch panel including (i) at least one birefringent base material having optical axes in respective two directions in a plane and (ii) a protection plate provided so that the at least one birefringent base material is sandwiched between the protection plate and the display panel,

polarized light which has exited from the polarizing plate entering the at least one birefringent base material,

(A) a polarization direction of the polarizing plate being parallel to a longitudinal or traverse direction of a display surface of the display apparatus, and

(B) the display panel being provided with the touch panel so that an angle between one of the optical axes of the at least one birefringent base material and the polarization direction of the polarizing plate falls within a range from minus 11° to 11°.

Actually, a display apparatus including a touch panel, employed as, e.g., a digital signage or an electronic blackboard, is hardly viewed from obliquely above or from obliquely below. Therefore, in terms of practical use, the display apparatus needs only to prevent rainbow unevenness from being generated when the display apparatus is viewed from a horizontal and traverse direction.

The inventors of the present invention made a diligent study of how a display apparatus including a touch panel prevents rainbow unevenness from being visually recognized, the touch panel including a protection plate so that a surface of the protection plate is a first surface of the touch panel which first surface is opposite to a second surface of the touch panel which second surface faces a display panel, i.e., a surface of the touch panel which surface is closest to a viewer. As a result of the diligent study, the inventors of the present invention found the following result.

That is, the display apparatus needs to meet the following two conditions in order to prevent rainbow unevenness which can be generated when the display apparatus is viewed from a horizontal and traverse direction. Assume here that (i) an x-y planar surface is parallel to a display surface of the display apparatus and (ii) the horizontal and traverse direction from which the display apparatus which is stood is viewed is a y direction.

One of the two conditions is that an absorption axis of a polarizing plate of the display panel should be parallel to a longitudinal or traverse direction of the display surface of the display apparatus, i.e., an x direction or the y direction.

The other of the two conditions is that an angle between one of optical axes of a birefringent base material and the absorption axis of the polarizing plate of the display panel should fall within 11°.

The inventors of the present invention found that (i) rainbow unevenness is visually recognized most remarkably when the display apparatus including the touch panel that includes the protection plate is viewed at a viewing angle of 78°, and (ii) a rainbow-like color band starts to be visually recognized at a reflectivity of more than 12% at which an s-wave is reflected on an interface between an air layer and a protection layer that is provided so that a surface of the protection layer is the display surface.

Therefore, it is possible to prevent the rainbow unevenness from being visually recognized by causing the s-wave to be reflected on the interface between the air layer and the protection layer at a reflectivity of not more than 12% at the viewing angle of 78°.

The inventors of the present invention further found that it is possible to cause the s-wave to be reflected on the interface between the air layer and the protection layer at the reflectivity of not more than 12% at the viewing angle of 78°, by causing the angle between the one of the optical axes of the birefringent base material and a polarization direction of the polarizing plate to fall within a range from minus 11° to 11°.

Therefore, the display apparatus including the touch panel that includes the protection plate is configured so that (i) the absorption axis of the polarizing plate of the display panel is parallel to the longitudinal or traverse direction of the display surface of the display apparatus and (ii) the angle between the one of the optical axes of the birefringent base material and the absorption axis of the polarizing plate of the display panel falls within 11°. This configuration makes it possible to reduce a case where a viewer visually recognizes rainbow unevenness when the viewer views the display apparatus from a traverse direction that is a direction in which the display apparatus is actually viewed.

Needless to say, it is possible to further prevent generation of rainbow unevenness by causing the one of the optical axes of the birefringent base material to be parallel or perpendicular to the polarization direction of the polarizing plate.

Further, the invention of the present application can prevent generation of rainbow unevenness without additionally providing a film such as a ¼ wavelength plate in a typical display apparatus including a touch panel. It is therefore possible to reduce manufacturing cost.

In terms of cost, heat resistance, etc., it is preferable that the at least one birefringent base material be made from polyethylene terephthalate. Alternatively, it is preferable that the at least one birefringent base material be a wavelength plate. By employing, as the at least one birefringent base material, a wavelength plate in which an optical axis is controlled, it is possible to more easily control an angle between the one of the optical axes of the at least one birefringent base material and an absorption axis of the polarizing plate.

It is further preferable to configure the display apparatus including the touch panel of the present invention so that (i) the at least one birefringent base material includes a plurality of birefringent base materials, (ii) electrodes for detecting a touch position of a position detecting object are provided for each of the plurality of birefringent base materials, and (iii) each of the plurality of birefringent base materials has optical axes that extend in a substantially identical direction.

According to the configuration, even the display apparatus including the touch panel, in which the electrodes for detecting the touch position of the position detecting object are provided for each of the plurality of birefringent base materials, can prevent generation of rainbow unevenness without additionally using a film such as a ¼ wavelength plate.

Assume that the display apparatus including the touch panel which display apparatus has a 15-inch display surface (display size) is horizontally placed, e.g., placed on a desk, and is viewed from an oblique direction at a viewing distance of 40 cm and at a central viewing angle of 30°. In this case, a viewing angle at an edge of the display surface is approximately 48° at which (i) colored transmitted light starts to be recognized and (ii) a difference in transmittance is approximately 10%.

Therefore, an observer who observes a display apparatus having a 15-inch or larger display surface constantly recognizes rainbow unevenness.

The present invention is particularly effective in a case where a display apparatus has a 15-inch or larger display surface.

The present invention is not limited to the description of the above embodiment, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The present invention is applicable to a display apparatus including a touch panel that includes a birefringent base material which touch panel polarized light enters, the polarized light having exited from a display panel (e.g., a liquid crystal panel) that includes a polarizing plate so that a surface of the polarizing plate is a surface of the display panel.

### REFERENCE SIGNS LIST

1: Display apparatus
10: Main body of display apparatus
11: Backlight
12: Display panel
13, 14: Substrate
15: Optical modulation layer
16: Display cell
17, 18: Polarizing plate
20: Touch panel
21: Sensor body
22: Circuit section
23: Protection film
24, 25: Adhesive layer
26: Protection plate
27: Adhesive layer
28: Antireflection layer
30: Double-side sensor film
31: Birefringent base material
32: Y electrode pattern
33: X electrode pattern
34: Y electrode
34a: Connection line
35: Y electrode column
36: Drawing wiring
37: X electrode
37a: Connection line
38: X electrode row
81: Single-side sensor film
81a: Sensor surface
82: Adhesive layer
83: Single-side sensor film
83a: Sensor surface
84: Single-side sensor film
84a: Sensor surface
85: Space
101: Polarizing plate
102: Birefringent film base material
103: Polarizing plate

1. A display apparatus, comprising:
a display panel from which polarized light exits; and
a touch panel including at least one birefringent base material that has optical axes in respective two directions in a plane,
the polarized light which has exited from the display panel entering the at least one birefringent base material, and
one of the optical axes of the at least one birefringent base material being parallel or perpendicular to a polarization direction of the polarized light which enters the at least one birefringent base material.

2. A display apparatus, comprising:
a display panel including a polarizing plate so that a surface of the polarizing plate is a surface of the display panel; and
a touch panel including (i) at least one birefringent base material having optical axes in respective two directions in a plane and (ii) a protection plate provided so that the at least one birefringent base material is sandwiched between the protection plate and the display panel,
polarized light which has exited from the polarizing plate entering the at least one birefringent base material,
a polarization direction of the polarizing plate being parallel to a longitudinal or traverse direction of a display surface of the display apparatus, and
the display panel being provided with the touch panel so that an angle between one of the optical axes of the at least one birefringent base material and the polarization direction of the polarizing plate falls within a range from minus 11° to 11 °.

3. The display apparatus as set forth in claim 1, wherein the at least one birefringent base material is made from polyethylene terephthalate.

4. The display apparatus as set forth in claim 1, wherein the at least one birefringent base material is a wavelength plate.

5. The display apparatus as set forth in claim 1, wherein the at least one birefringent base material includes a plurality of birefringent base materials, and each of the plurality of birefringent base materials has optical axes that extend in a substantially identical direction.

6. The display apparatus as set forth in claim 1, having a display surface which is 15 inches or larger in size.

7. The display apparatus as set forth in claim 2, wherein the at least one birefringent base material is made from polyethylene terephthalate.

8. The display apparatus as set forth in claim 2, wherein the at least one birefringent base material is a wavelength plate.

9. The display apparatus as set forth in claim 2, wherein the at least one birefringent base material includes a plurality of birefringent base materials, and each of the plurality of birefringent base materials has optical axes that extend in a substantially identical direction.

10. The display apparatus as set forth in claim 2, having a display surface which is 15 inches or larger in size.
